(19) United States
(12) Patent Application Publication
(10) Pub. No.: US 2010/0279255 A1
(43) Pub. Date: Nov. 4, 2010

(54) Vehicle simulator system

(75) Inventor: ROBERT L. WILLIAMS, II, ATHENS, OH (US)

Correspondence Address: CALFEE HALTER & GRISWOLD, LLP, 800 SUPERIOR AVENUE, SUITE 1400, CLEVELAND, OH, 44114, US

(73) Assignee: OHIO UNIVERSITY, ATHENS, OH (US)

(21) Appl. No.: 12/032,801

(22) Filed: Feb. 18, 2008

Related U.S. Application Data
(60) Provisional application No. 60/890,423, filed on Feb. 16, 2007.

(51) Int. Cl. G09B 9/02

(52) U.S. Cl. 434/29

(57) ABSTRACT

A vehicle simulation system may include: a platform positioned within a three-dimensional workspace, at least six upper support members positioned outside the three-dimensional workspace, at least six upper adjustable cables routed from corresponding upper support members and secured to the platform to apply at least a portion of upward tension to the platform, and a vehicle secured to the platform. The vehicle may provide one or more occupants with a simulated experience within a three-dimensional virtual environment as the upper adjustable cables are adjustably extended and retracted in a coordinated fashion to maneuver the platform.

### CROSS-REFERENCE TO RELATED APPLICATIONS

This application claims the benefit of U.S. Provisional Patent Application No. 60/890,423, filed Feb. 16, 2007, the contents of which are fully incorporated herein by reference.

### BACKGROUND

Flight simulation has been achieved using platform-based octahedral hexapods since the 1960s (see FIGS. 1 and 2). These types of systems have been used to provide realistic flight simulations including transference of pilot training to real-world flight. However, they are heavy, expensive, and may present unnecessary safety risks for at least certain applications. For additional information on platform-based octahedral hexapods see Stewart, A Platform with Six Degrees of Freedom, Proceedings of the IMechE, 180 Part 1(15), pages 371-385 (1965-66); Gough et al., Universal Tyre Test Machine, Proceedings of the FISITA Ninth International Technical Congress, pages 117-137 (1962); U.S. Pat. No. 3,295,224 to Cappel; issued Jan. 3, 1967, and Bonev, The True Origins of Parallel Robots, printed from http://www.parallemic.org/Reviews/Review007.html, published on Jan. 24, 2003. The contents of each of the documents identified in this paragraph are fully incorporated herein by reference.

Cable-suspended, or wire-driven, robots have been previously disclosed. Pioneers in this area include the NIST RoboCrane (see FIG. 3) and the Charlotte robot. Additionally, a parallel wire-driven robot for wind tunnels has been used to pose small, reduced-scale models of an aircraft. For additional information on the NIST RoboCrane, see U.S. Pat. No. 4,883,184 to Albus, issued Nov. 28, 1989, and Albus et al., The NIST ROBOCRANE, Journal of Robotic Systems, 10(5), pages 709-724 (1993). For additional information on the Charlotte robot, see Campbell et al., Charlotte Robot Technology for Space and Terrestrial Applications, 25^{th} International Conference on Environmental Systems, San Diego, SAE Article 951520 (1995). For additional information on the use of a parallel wire-driven robot to pose reduced-scale models of aircraft in wind tunnels, see Lafourcade et al., Design of a Parallel Wire-Driven Manipulator for Wind Tunnels, Proceedings of the Workshop on Parallel Mechanisms and Manipulators, Quebec City, Canada: pages 187-194 (2002). The contents of each of the documents identified in this paragraph are fully incorporated herein by reference.

### SUMMARY

In one aspect a vehicle simulation apparatus is provided. In one embodiment, the vehicle simulation apparatus includes: a platform positioned within a three-dimensional workspace, at least six upper support members positioned outside the three-dimensional workspace, at least six upper adjustable cables routed from corresponding upper support members and secured to the platform to apply at least a portion of upward tension to the platform, wherein the upper adjustable cables are adjustably extended and retracted in a coordinated fashion to maneuver the platform, and a vehicle secured to the platform to provide one or more occupants with a simulated experience within a three-dimensional virtual environment during the maneuvering.

### DRAWINGS

These and other features, aspects, and advantages of the present invention will become better understood with regard to the accompanying drawings, following description, and appended claims.

FIG. 1 is perspective view of an existing flight simulator with a octohedral hexapod motion system;

FIG. 2 is perspective view of another existing flight simulator with a octohedral hexapod motion system and a visual system with a dome;

FIG. 3 is a perspective diagram of an existing cable robot system with a cable-suspended platform and a camera mounted on the platform;

FIG. 4 shows top and side view block diagrams of an exemplary embodiment of a vehicle simulator system;

FIG. 5 shows top and side view kinematic diagrams of the vehicle simulator system of FIG. 4;

FIG. 6 shows a perspective view of a statics free-body diagram of a an exemplary embodiment of a cable suspended vehicle platform for the vehicle simulator system of FIG. 4;

FIG. 7 shows exemplary poses of the vehicle platform of FIG. 6 within an exemplary three-dimensional (3D) workspace;

FIG. 8 shows additional exemplary poses of the vehicle platform of FIG. 6 within an exemplary 3D workspace;

FIG. 9 shows exemplary signal levels over time for exemplary command signals in conjunction with an exemplary desired Cartesian motion sequence for the vehicle platform of FIG. 5;

FIG. 10 shows exemplary cable lengths over time for the exemplary desired Cartesian motion sequence of FIG. 9;

FIG. 11 shows exemplary calculated cable tensions over time using a first algorithm for the exemplary desired Cartesian motion sequence of FIG. 9;

FIG. 12 shows exemplary calculated cable tensions over time using a second algorithm for the exemplary desired Cartesian motion sequence of FIG. 9;

FIG. 13 shows exemplary calculated cable tensions over time using a third algorithm for the exemplary desired Cartesian motion sequence of FIG. 9;

FIG. 14 is a perspective view of another exemplary embodiment of a vehicle simulator system in operation;

FIG. 15 shows top and side view kinematic diagrams of the vehicle simulator system of FIG. 14;

FIG. 16 is a perspective view of yet another exemplary embodiment of a vehicle simulator system in operation;

FIG. 17 is another perspective view of the vehicle simulator system of FIG. 16;

FIG. 18 is flow chart of an exemplary embodiment of an iterative process for controlling motion of an exemplary cable-suspended vehicle platform;

FIG. 19 shows an exemplary 3D workspace for an exemplary cable-suspended vehicle platform using a first algorithm for controlling motion;

FIG. 20 shows an exemplary 3D workspace for an exemplary cable-suspended vehicle platform using a second algorithm for controlling motion;

FIG. 21 shows an example of the influence of inertial forces on exemplary trajectories of an exemplary cable-suspended vehicle platform within an exemplary 3D workspace;

FIG. 22 is a block diagram of an exemplary embodiment of a side acceleration control system for controlling motion of an exemplary cable-suspended vehicle platform;

FIG. 23 is a block diagram of an exemplary embodiment of a controller for the side acceleration control system of FIG. 22;

FIG. 24 shows exemplary membership functions for an exemplary input variable for the controller of FIG. 23;

FIG. 25 is yet another perspective view of the vehicle simulator system of FIG. 16;

FIG. 26 is a block diagram of an exemplary embodiment of a roll angle control system for controlling motion of an exemplary cable-suspended vehicle platform;

FIG. 27 is a block diagram of an exemplary embodiment of a longitudinal acceleration control system for controlling motion of an exemplary cable-suspended vehicle platform;

FIG. 28 is a block diagram of an exemplary embodiment of a controller for the longitudinal acceleration control system of FIG. 27;

FIG. 29 shows exemplary membership functions for an exemplary input variable for the controller of FIG. 28;

FIG. 30 is still another perspective view of the vehicle simulator system of FIG. 16;

FIG. 31 is a block diagram of an exemplary embodiment of a pitch angle control system for controlling motion of an exemplary cable-suspended vehicle platform;

FIG. 32 shows exemplary signal levels over time for exemplary longitudinal and side acceleration command signals in conjunction with an exemplary simulation scenario;

FIG. 33 shows exemplary signal levels over time for exemplary motion variables in conjunction with the simulation scenario of FIG. 32;

FIG. 34 shows exemplary cable lengths over time for the exemplary simulation scenario of FIG. 32;

FIG. 35 shows exemplary cable tensions over time for the exemplary simulation scenario of FIG. 32; and

FIG. 36 shows a perspective view of a statics free-body diagram of an exemplary embodiment of a cable-suspended vehicle platform for an exemplary vehicle simulator system.

### DESCRIPTION

The following paragraphs include definitions of exemplary terms used within this disclosure. Except where noted otherwise, variants of all terms, including singular forms, plural forms, and other affixed forms, fall within each exemplary term meaning. Except where noted otherwise, capitalized and non-capitalized forms of all terms fall within each meaning.

“Comprising,” “containing,” “having,” and “including,” as used herein, except where noted otherwise, are synonymous and open-ended. In other words, usage of any of these terms (or variants thereof) does not exclude one or more additional elements or method steps from being added in combination with one or more delineated elements or method steps.

“Or,” as used herein, except where noted otherwise, is inclusive, rather than exclusive. In other words, “or’ is used to describe a list of alternative things in which one may choose one option or any combination of alternative options. For example, “A or B” means “A or B or both” and “A, B, or C” means “A, B, or C, in any combination or permutation.” If “or” is used to indicate an exclusive choice of alternatives or if there is any limitation on combinations of alternatives, the list of alternatives specifically indicates that choices are exclusive or that certain combinations are not included. For example, “A or B, but not both” is used to indicate use of an exclusive “or” condition. Similarly, “A, B, or C, but no combinations” and “A, B, or C, but not the combination of A, B, and C” are examples where certain combinations of alternatives are not included in the choices associated with the list.

A virtual reality (VR)-based vehicle simulator system (VSS) with whole-body haptics capable of providing one or more human occupants with a simulated, VR experience during one or more simulation scenarios is described herein. Any of a variety of real-life experiences, theoretical life experiences, fictional experiences, and other experiences suitable for simulation may be provided in any combination by a given simulation scenario. The simulation scenarios may be for training purposes, entertainment purposes, therapy purposes, or any other suitable purpose. The scenarios may be interactive in response to actions taken by one or more human occupants, pre-planned regardless of occupant behavior, or a combination thereof. A given VR simulation may be in real-time, including interactive responses. The simulations may also be controlled in some other manner, such as ranging from faster to slower than would be experienced in the real world in order to suit the purpose of a particular scenario.

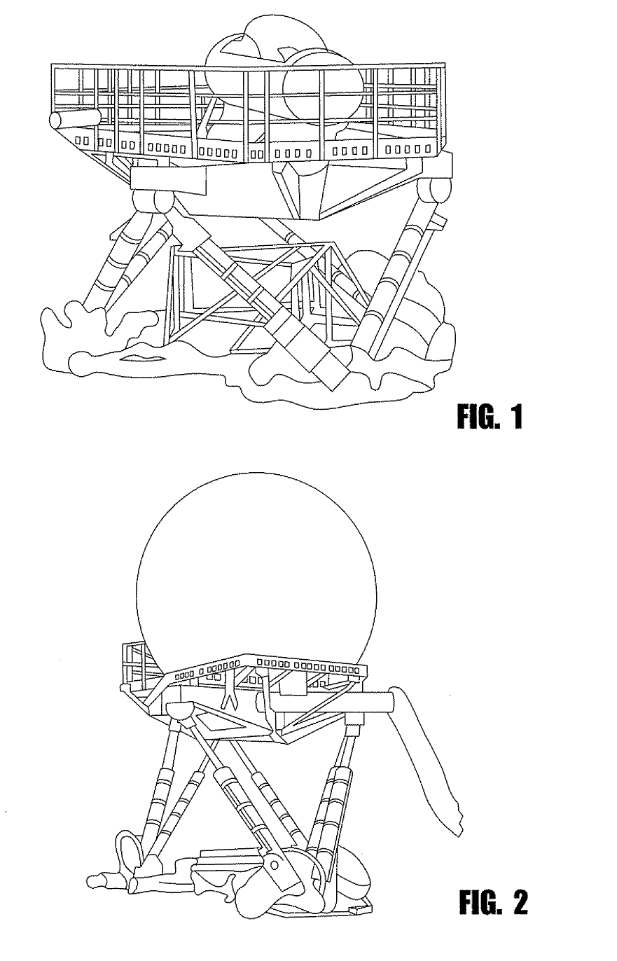

In one embodiment, the vehicle simulator system may include a visual system with three-dimensional (3D) graphics for simulating what the vehicle occupant would be seeing, haptic motion input devices that simulate vehicle controls, 3D surround-sound audio for simulating aural cues, articulating fans for simulating haptic cues, an olfactory generator for simulating smells, and a cable-controlled motion system for simulating whole-body haptic cues. The cable-controlled motion system may include a platform and a vehicle that accommodates one or more human occupant. The cable-controlled motion system may be used in lieu of existing octahedral hexapod motion systems (see FIGS. 1 and 2), such as a Stewart platform-based motion system used in flight simulators. The cable-controlled motion system may provide a lighter, more economical, stiff, high bandwidth, cable-suspended vehicle simulation system than a comparable system using an octahedral hexapod motion system.

The vehicle simulator system, for example, may be used for a flight simulator or any other type of simulator. The system also may be used to provide an economical, realistic simulation with full-body motion for research and development, vehicle design, entertainment, rehabilitation, therapy, and other suitable applications.

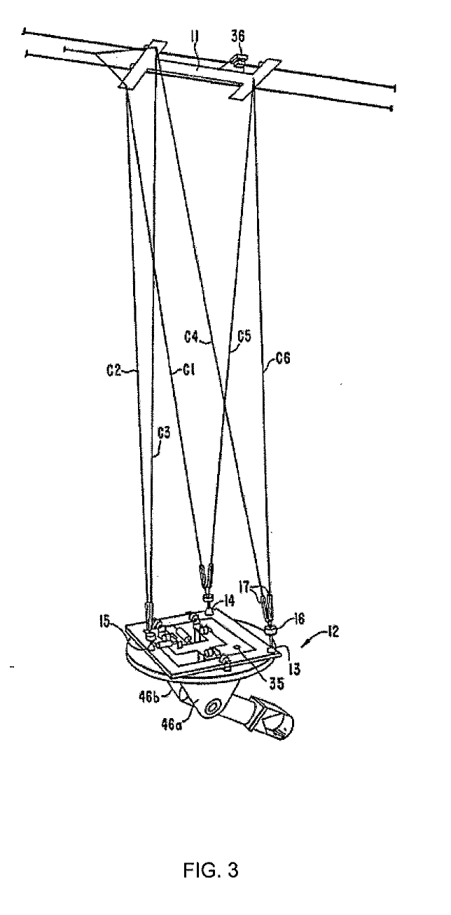

From one perspective, the vehicle simulator system provided herein presents a lighter, more economical, stiff, high bandwidth, cable-suspended motion system to replace octahedral hexapod motion platforms in previous simulator systems. For example, the vehicle simulator system uses at least six stiff, lightweight cables in place of the six hydraulic actuators used in the octahedral hexapod motion platforms. From another perspective, the vehicle simulator system presents a cable-suspended motion system, such as that was used in the NIST RoboCrane (see FIG. 3) adapted to carry one or more human occupants in a vehicle for simulating a variety of vehicle motions. In one embodiment, the cable-controlled motion system may also use one or more additional cables to apply tension to enhance gravitational forces to further constrain movement of the vehicle platform. In another embodiment, the cable-controlled motion system may also use a gravity offload device in conjunction with one or more additional cables to offset the effect of gravitational forces on movement of the vehicle platform.

Many types of vehicles may be simulated using the vehicle simulator system. For example, flight simulators can provide a VR environment of a cockpit (or other duty stations) of an aircraft. Various levels of performance and sophistication can implemented in the vehicle simulator system to immerse the occupant in an appropriate VR environment based on a balance of performance and cost. The vehicle simulator system may be safer and more economical than, for example, simulators with Stewart platform-based motion systems (see FIGS. 1 and 2) and thus may find use in more widespread application in various missions than earlier simulator platforms.

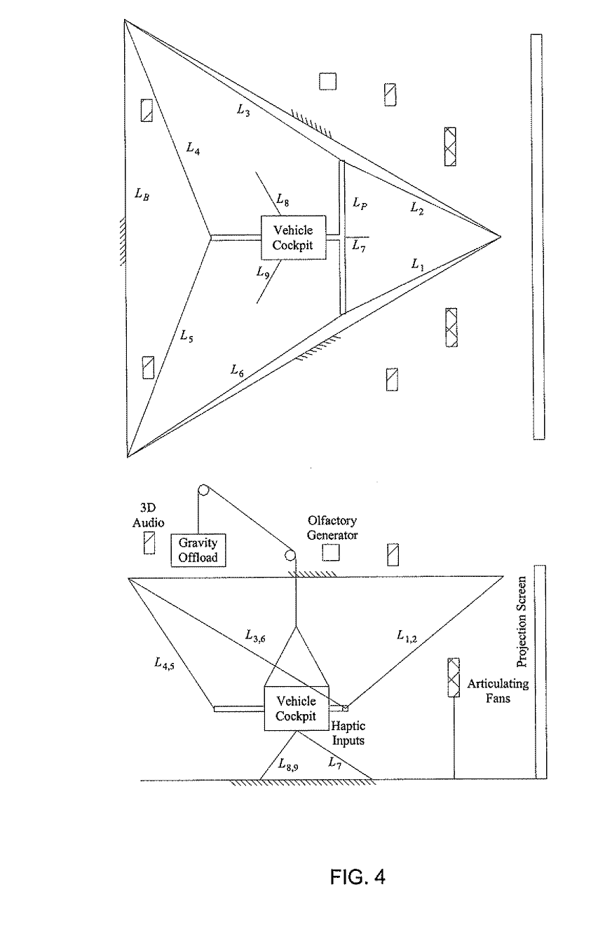

With reference to FIG. 4, an exemplary embodiment of the vehicle simulator system may include a vehicle and a cable-controlled motion system. The motion system may provide motion with six degrees of freedom (dof) (i.e., xyz translations, roll-pitch-yaw rotations) for an occupant of the vehicle using, for example, six ceiling-mounted cables to suspend a vehicle platform. Rotation of the vehicle platform may be constrained. Translational workspace for the vehicle platform, described in more detail below, can be quite large. Motors and cable reels may be fixed to the ceiling and the cable ends may be secured to the platform carrying the vehicle. The system's bandwidth and accelerations may be designed to allow a variety of vehicle simulations. The vehicle (e.g., cockpit) may be a real vehicle (or a portion thereof) from the real world or a simulated vehicle (or a portion thereof), insofar as possible (see exemplary vehicles listed below). The vehicle may include real or simulated input devices such as flight sticks, foot pedals, or driving wheels. The input devices may include haptic inputs with control or force loading (i.e., force-feedback) to resist movement in a manner that makes the simulation more realistic.

The vehicle simulator system may provide a means for humans to ride and interact in various dynamic simulated vehicle situations. Actual cockpits, truck cabs, other types of operator compartments, and passenger compartments from real-world vehicles, including the vehicle input devices (steering wheels, flight sticks, etc.) may be used to increase realism. The real-world vehicle (or portion thereof) may be suspended using six active cables for vehicle simulation with motion. In various embodiments, the vehicle simulator system may use gravity, actuation redundancy, or opposing cables to fully constrain the vehicle platform.

For example, in one embodiment, the general cabling design of the NIST RoboCrane (FIG. 3) may be modified to include three cables pulling down for crisp downward motions and to suit performance and load factors associated with the vehicle simulator system. In this embodiment, the vehicle simulator system does not merely rely on gravity for downward accelerations. Moreover, downward accelerations larger than g can be achieved. The down-pulling cables may be used to fully constrain the vehicle platform. FIG. 4 also shows an optional passive gravity off-load system that may be used to partially relieve weight due to gravity. With this option, smaller motors may be used controlling the cables for the same desired accelerations in motion. Additional redundant cabling and support systems (not shown) may be included in the vehicle simulator system to ensure human occupant (i.e., passenger) safety during vehicle simulations with motion.

An exemplary feature of the vehicle simulator system is immersion of the occupant in a realistic VR environment with real or simulated controls, indicators, and displays in conjunction with the perspective of the occupant in the vehicle (e.g., cockpit) allowing interaction with the system. The vehicle simulator system allows for a large variety of real-world vehicles to be simulated. For example, various types of real-world vehicles may be mounted on the cable-suspended platform, including, but not limited to: i) aircraft, ii) gliders, iii) hang gliders, iv) dreamtime ‘Peter Pan’ flight, v) automobiles, vi) motorcycles, vii) mountain bikes, viii) skateboards, ix) tractors, x) four-wheelers, xi) snow-mobiles, xii) roller coasters and other thrill rides, xiii) sailboats, xiv) windsurfing boards, xv) kayaks, xvi) jet skis, xvii) downhill and cross-country skis, and xviii) horses for equestrian and other types of riding.

The vehicle simulator system could be modified to allow various real-world or simulated vehicles to be interchanged as desired in the same laboratory, clinic, or arcade. Thus, one cable-suspended vehicle platform and accompanying VR systems could handle many different needs. Even given a specific type of vehicle, such as automobiles, different options may be programmed and presented to the user for a choice to represent different automobiles with different physical characteristics and different motion profiles based on a combination of the physical characteristics of the vehicle and the terrain or environment being traversed.

With reference to FIG. 4, an exemplary embodiment of the vehicle simulator system may include the following components for VR immersion with whole-body haptics (i.e., vehicle simulator motion): i) six-cable-suspended motion system, ii) real-world or simulated vehicle (e.g., cockpit), iii) realistic input devices with haptics (where possible) for interaction, iv) a visual system with 3D video projected, for example, on a projection screen, in a VR cave or dome, or within a head-mounted display (HMD), v) 3D surround-sound audio for simulating aural cues, vi) articulating fans for simulated breezes associated with motion and other haptic cues, vii) an olfactory generator for simulating realistic smells, viii) system for partial gravity offload to allow smaller control motors, ix) sensors for inputs and motion feedback including 6-dof tracking technology, and x) redundant cables to improve safety and reliability of the system (not shown)

In conjunction with the plurality of vehicle applications for suspended vehicle simulation with motion, there are also various applications or missions that are common to many of the possible vehicles for which the vehicle simulator system may be implemented. For example, the system may be adapted for the following applications or missions: i) research and development, ii) engineering design and simulation of vehicles, iii) operator training, iv) safety research and training, v) rehabilitation, vi) therapy (e.g., emotional therapy for autistic or mentally-handicapped persons), vii) entertainment, viii) recreation for city dwellers, ix) virtual access to practice a task or experience in the real world prior to the actual real-world attempt, x) serious gaming, including military training or remote control, and xi) high-end arcades that are more interactive for the human player.

The vehicle simulator system may operate in one or more control modes for vehicle simulation. In one control mode, pre-programmed or ‘canned’ motion of the vehicle in which a human can ride passively to experience the simulated dynamics may be provided. Alternatively, in an active, real-time control mode, the human ‘pilot’ (i.e., occupant) may enter vehicle motion commands through realistic control inputs and may experience the dynamics of such commands in the resulting simulated motions.

In one embodiment, the vehicle simulator system may immerse a vehicle occupant in a realistic VR environment with a real cockpit and real input devices allowing interaction with the system. The system may include 3D stereo vision graphics with realistic vehicle environments. The graphics may be delivered, for example, via a projection screen or a wireless head-mounted display (HMD)). The system may also provide 3D surround sound audio, articulating fans for motion perception enhancement, and an olfactory generator for realistic smells to increase the sense of realism in our vehicle simulations.

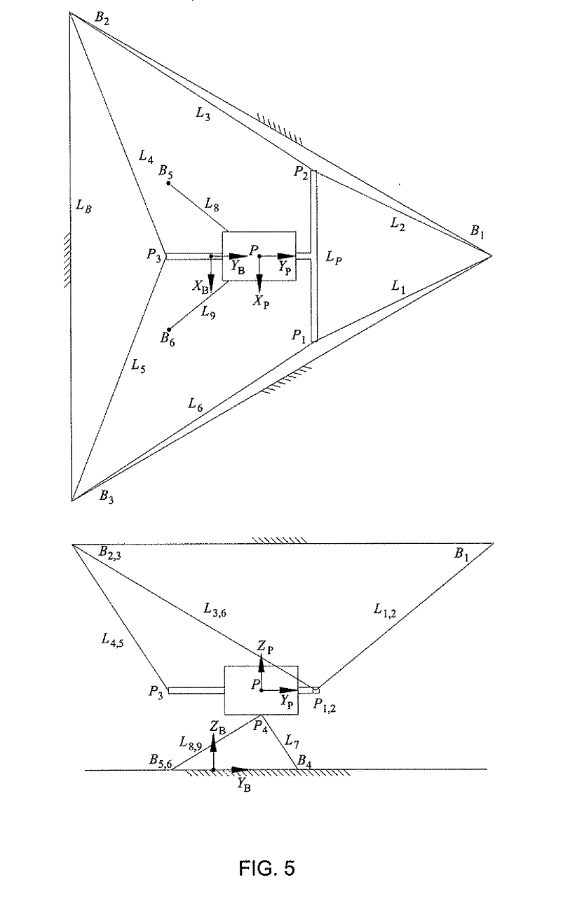

With reference to FIG. 5, an exemplary vehicle simulator system kinematic diagram shows that the fixed base Cartesian coordinate frame is {B} and that the vehicle platform has Cartesian coordinate frame {P} fixed to its CG. The active control tensioning motors may be mounted to the base frame; two motors each at fixed cable connection points B₁, B₂, and B₃, and one motor each at fixed cable connection points B₄, B₅, and B₆. The cable-connection vertices of the vehicle platform are P₁, P₂, P₃, and P₄, and point P is the centroid of the moving vehicle platform. As shown in FIG. 5, equilateral triangles may be assumed for the fixed ceiling base points, the vehicle platform upper cable-connection points, and the fixed floor base points with sides L_{B} (shown), L_{P} (shown), and L_{Bfloor} (not shown), respectively. In other embodiments, any desired geometry may be used for these points for the kinematics equations presented in the following paragraphs.

The lengths of the nine active cables are Lᵢ, i=1, 2, . . . , 9. As shown in FIG. 5, the upper cables may be described as follows: cable L₁ connects B₁ to P₁, cable L₂ connects B₁ to P₂, cable L₃ connects B₂ to P₂, cable L₄ connects B₂ to P₃, cable L₅ connects P₃ to B₃, and cable L₆ connects P₁ to B₃. As shown, the lower three down-pulling cables may be described as follows: cable L₇ connects P₄ to B₄, cable L₈ connects P₄ to B₅, and cable L₉ connects P₄ to B₆.

The inverse pose kinematics problem for the vehicle simulator system may be stated: given the desired moving vehicle platform pose [_{P}^{B}T], calculate the nine active cable lengths Lᵢ, i=1, 2, . . . , 9. The solution to this problem may be used as the basis for a pose control scheme, executing both pre-planned trajectories or real-time interactive vehicle simulations based on interaction with one or more human occupant and a virtual vehicle dynamics model. The vehicle simulator system inverse pose kinematics solution is straight-forward and poses no computational challenge for real-time implementation. For example, given the vehicle platform pose, the vehicle platform cable connection points P₁, P₂, P₃, and P₄ can be found. Then, the inverse pose solution may be determined by calculating the cable lengths using the Euclidean norm of the appropriate vector differences between the various moving and fixed cable connection points. The inverse pose kinematics solution yields a closed-form solution.

Given [_{P}^{B}T], the moving cable connection points P₁, P₂, P₃, and P₄ referenced to the fixed base frame {B} can be calculated using:

{^{B}Pᵢ}=[_{P}^{B}T]{^{P}Pᵢ} i=1, 2, 3, 4 (1).

Each position vector in Equation (1) may be augmented with a ‘1 ’ in the fourth row to make the 4×4 matrix multiplication indices work. The constant relative vectors {^{P}Pᵢ} are known from platform geometry, the four position vectors to point Pᵢ from the origin of {P}, expressed in {P} coordinates. The resulting vectors {^{B}Pᵢ} are the position vectors to point Pᵢ from the origin of {B}, expressed in {B} coordinates. Given the four moving cable connection points from Equation (1), the nine unknown cable lengths can be found using the following Euclidean norms of the appropriate vector differences between fixed base and vehicle platform cable-connection points:

$${L}_{1} = ‖ {}_{}^{B}{B}{}_{1}^{} - {}_{}^{B}{P}{}_{1}^{} ‖ {L}_{2} = ‖ {}_{}^{B}{B}{}_{1}^{} - {}_{}^{B}{P}{}_{2}^{} ‖ {L}_{3} = ‖ {}_{}^{B}{B}{}_{2}^{} - {}_{}^{B}{P}{}_{2}^{} ‖ \\ {L}_{4} = ‖ {}_{}^{B}{B}{}_{2}^{} - {}_{}^{B}{P}{}_{3}^{} ‖ {L}_{5} = ‖ {}_{}^{B}{B}{}_{3}^{} - {}_{}^{B}{P}{}_{3}^{} ‖ {L}_{6} = ‖ {}_{}^{B}{B}{}_{3}^{} - {}_{}^{B}{P}{}_{1}^{} ‖ \\ {L}_{7} = ‖ {}_{}^{B}{B}{}_{4}^{} - {}_{}^{B}{P}{}_{4}^{} ‖ {L}_{8} = ‖ {}_{}^{B}{B}{}_{5}^{} - {}_{}^{B}{P}{}_{4}^{} ‖ {L}_{9} = ‖ {}_{}^{B}{B}{}_{6}^{} - {}_{}^{B}{P}{}_{4}^{} ‖ . \qquad ( 2 )$$

The forward pose kinematics solution may be used for simulation and sensor-based control of the vehicle simulator system. The forward pose kinematics problem may be stated: given the nine active cable lengths Lᵢ, i=1, 2, . . . , 9, calculate the resulting moving vehicle platform pose [_{P}^{B}T]. Unlike most cable robot forward pose kinematics problems, a closed-form solution for the vehicle simulator system of FIG. 5 may be used. There may be multiple solutions, but generally the correct solution can be easily identified.

The closed-form vehicle simulator system forward pose kinematics solution may be based on finding the intersection of three spheres (four times in succession). At each step, each sphere center and radius is known. The closed-form three-spheres' intersections algorithm is straight-forward and not computationally-intensive. For additional information on the closed-form three-spheres' intersections algorithm, see Williams II et al., 3D Cable-Based Cartesian Metrology System, Journal of Robotic Systems, 21(5), pages 237-257 (2004), the contents of which are fully incorporated herein by reference.

The first step in the forward pose kinematics solution may be to calculate lower platform cable-connection point P₄ given the lower active cable lengths L₇, L₈, and L₉ using the intersection of three spheres algorithm and knowing the floor-fixed base points. Then, vehicle platform cable-connection points P₁, P₂, and P₃ can be similarly found, by intersecting three known spheres three different times, each time using this P₄ as one of the sphere centers. Referring to a sphere as a vector center point c and scalar radius r, (c,r), the vehicle simulator system forward pose kinematics solution is summarized as follows: i) P₄ is the intersection of: (B₄,L₇), (B₅,L₈), (B₆,L₉); ii) P₁ is the intersection of: (P₄,l_{P1}), (B₁,L₁), (B₃,L₆); iii) P₂ is the intersection of: (P₄,l_{P2}), (B₁,L₂), (B₃,L₃); and iv) P₃ is the intersection of: (P₄,l_{P3}), (B₂,L₄), (B₃,L₅), where the three known lengths fixed on the platform are l_{P1}=∥P₁−P₄∥, l_{P2}=∥P₂−P₄∥, and l_{P3}=∥P₃−P₄∥. For a detailed solution for the intersection of three spheres, see Williams II et al. (2004). Also, see Williams II et al. (2004) For a discussion of imaginary solutions, singularities, and multiple solutions.

Returning to the forward pose kinematics solution, given ^{B}Pᵢ, the orthonormal rotation matrix [_{P}^{B}R] can be calculated using the definition that each column of this matrix expresses the X, Y, and Z unit vectors of {P} with respect to {B}. These columns may be calculated as follows, from the vehicle platform geometry.

$${ }^{B} {\hat{X}}_{P} = {\frac{{}_{}^{B}{P}{}_{1}^{} - {}_{}^{B}{P}{}_{2}^{}}{‖ {}_{}^{B}{P}{}_{1}^{} - {}_{}^{B}{P}{}_{2}^{} ‖} }^{B} {\hat{Y}}_{P} = \frac{{}_{}^{B}{P}{}_{5}^{} - {}_{}^{B}{P}{}_{3}^{}}{‖ {}_{}^{B}{P}{}_{5}^{} - {}_{}^{B}{P}{}_{3}^{} ‖} {\\ }^{B} {\hat{Z}}_{P} = {}_{}^{B}{\hat{X}}{}_{P}^{} \times {}_{}^{B}{\hat{Y}}{}_{P}^{} , \qquad ( 3 )$$

where ^{B}P₅ is the midpoint of P₁P₂. Finally, to find the platform control point P where the {P} frame is affixed, the following vector loop-closure equation may be used:

^{B}P_{P}=^{B}P₄−hd P^{B}R^{P}P₄ (4).

Given {^{B}P_{P}} and [_{P}^{B}R], the 4×4 description of pose, [_{P}^{B}T], may be determined as follows:

$${[}_{P}^{B} T ] = [ \begin{matrix} & & & \\ & {[}_{P}^{B} R ] & & {\{}^{B} {P}_{P} \} \\ & & & \\ 0 & 0 & 0 & 1\end{matrix} ] . \qquad ( 5 )$$

There are two solutions to the intersection point of three given spheres. Therefore, the forward pose kinematics problem yields a total of 2⁴=16 mathematical solutions after repeating the algorithm four times for the vehicle simulator system. It is generally straight-forward to determine the correct solution using logic in the forward pose kinematics solution implementation.

The down-pulling cables may simplify the forward pose kinematics solution in addition to improving upper cable tensioning.

Positive cable tensions are desired for safe and stable control during motion. First, gravity helps to ensure that the top six active cables remain in tension, as long as the rotations are not too far from the horizontal nominal orientation. Further, the cable-suspended platform of FIGS. 4 and 5 may be over-actuated (e.g., three more cables than the minimum number of six cables for a ceiling-mounted platform and 6-dof operation). This actuation redundancy may be used to attempt to ensure cable tensions for all motions. A pseudostatic model may be applied to attempt to maintain positive cable tensions using two methods: a pseudoinverse based actuation redundancy resolution scheme and then a method wherein the cable tensions of the three lower cables are specified and the remaining unknowns calculated without redundancy.

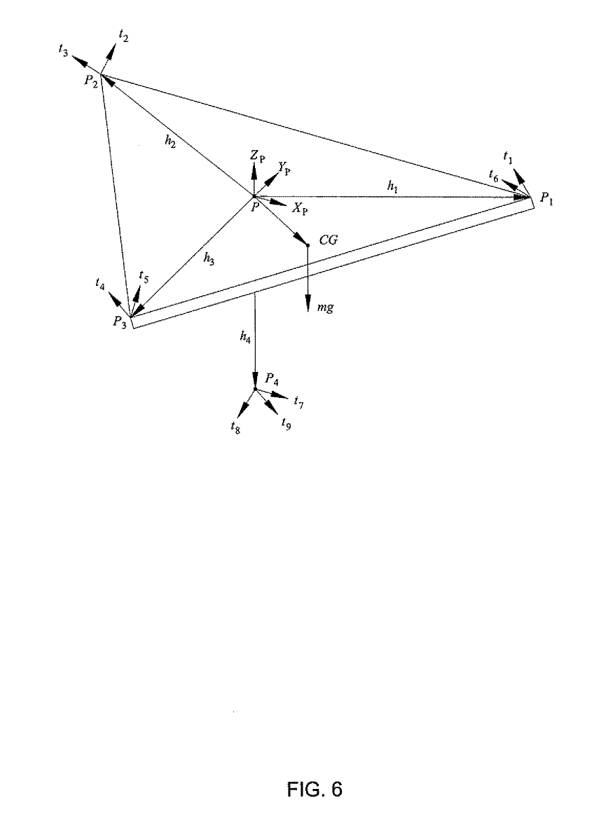

Statics modeling may be utilized for the six- and nine-cable vehicle simulator systems. Six active cables may connect in parallel pairs from corresponding pairs of fixed upper bases or support members to the vehicle platform. In other embodiments, the pairs of cables need not be arranged in parallel. The vehicle simulator system may include three additional active cable connected from fixed lower bases or support members to the vehicle platform. The active drive cables may have variable tensions which may be maintained as positive. For static equilibrium the sum of all active and passive cable tensions plus gravitational loading acting on the vehicle platform equals the resultant wrench exerted on the environment by the vehicle platform. For free-space pseudostatic motions, this resultant wrench is zero; when the tool is in contact with the environment, there is no platform motion, but the resultant wrench is non-zero. When the vehicle simulator system is used for free-space motions there is zero contact wrench for motion. Therefore, external loading on the vehicle platform would be due to gravity. However, the environment wrench may be included in case it is required for a particular application of the vehicle simulator system. FIG. 6 shows an exemplary statics free-body diagram for the vehicle platform where CG indicates the center of mass point. The nine active cable tension vectors are tᵢ, i=1, 2, . . . , 9. The pseudostatics Jacobian matrix may be derived based on the force and moment statics equations. The Jacobian matrix may be used to provide a linear transformation that maps scalar cable tension magnitudes into the Cartesian wrench of the vehicle platform.

The vector translational and rotational equations of static equilibrium may be expressed as follows:

$$\begin{matrix}{\sum }_{i = 1}^{9} {t}_{i} + m g = {F}_{R} , \\ and & ( 6 ) \\ {\sum }_{i = 1}^{9} {m}_{i} {+}_{P}^{B} {R}^{P} {P}_{CG} \times m g = {M}_{R} , & ( 7 )\end{matrix}$$

where tᵢ=tᵢ\hat{L}ᵢ is the vector cable tension applied to the vehicle platform by the i^{th} active drive cable and (in the positive cable length direction \hat{L}ᵢ and because tᵢ must be in tension; \hat{L}ᵢ are defined to point from the vehicle platform to the fixed base); m is the total mass of the vehicle platform with the vehicle; g={0 0 −g}^{T} is the gravity vector; mᵢ=_{P}^{B}Rpᵢ×tᵢ is the moment due to the i^{th} active cable tension (pᵢ is the moment arm from the vehicle platform control point P to the i^{th} active cable connection point, expressed in {P} coordinates); ^{P}P_{CG} is the position vector to the vehicle platform center of mass (CG) from the vehicle platform control point P; and F_{R} and M_{R} are the vector force and moment (taken together, wrench) exerted on the environment by the vehicle platform (both zero for free-space motions). Moments are summed about the platform control point P and all vectors must be expressed in a common frame, {B} in this paper. From FIG. 6, there may be four distinct moment arms for the nine cable tension moments about P, due to the symmetry in design:

$$\begin{matrix}{p}_{1} = {h}_{1} & {p}_{2} = {h}_{2} & {p}_{3} = {h}_{2} \\ {p}_{4} = {h}_{3} & {p}_{5} = {h}_{3} & {p}_{6} = {h}_{1} \\ {p}_{7} = {h}_{4} & {p}_{8} = {h}_{4} & {p}_{9} = {h}_{4} .\end{matrix} \qquad ( 8 )$$

Substituting these details above into Equations (6) and (7) yields the following:

[S]{t}={W_{R}−G} (9),

where {t}={t₁ t₂ . . . t₉}^{T} is the vector of active drive cable tension magnitudes, {G}={mg _{P}^{B}R^{P}P_{CG}×mg}^{T} is the gravity loading wrench vector, {W_{R}}={F_{R} M_{R}}⁷ is the external wrench vector exerted on the environment by the vehicle platform, and the active statics Jacobian matrix [S] is:

$$[ S ] = [ \begin{matrix}{\hat{L}}_{1} & {\hat{L}}_{2} & ⋯ & {\hat{L}}_{9} \\ - {\hat{L}}_{1} {\times }_{P}^{B} {Rp}_{1} & - {\hat{L}}_{2} {\times }_{P}^{B} {Rp}_{2} & ⋯ & - {\hat{L}}_{9} {\times }_{P}^{B} {Rp}_{9}\end{matrix} ] . \qquad ( 10 )$$

The active statics Jacobian matrix [S] may be readily adapted for resolved-rate (inverse velocity) control without additional computations. In other words, the inverse Jacobian matrix M may be closely related to the active statics Jacobian matrix of Equation (10): M=−S^{T}. In one embodiment, this may be utilized as a control mode for the vehicle simulator system. If the gravity offload device shown in FIG. 4 is included in the system, Equations (6) through (10) may be adjusted accordingly to consider the effect of gravity offload.

The statics equations can be used in to two ways. Given the active cable tensions {t} and each of the nine cable unit vectors \hat{L}ᵢ from kinematics analysis, forward statics analysis can calculate the external wrench {W_{R}} applied on the environment by the vehicle platform using Equation (9).

For control and vehicle simulation, the more useful problem to solve is inverse statics analysis. The statics equations can be used to calculate the required active cable tensions {t} given the vehicle platform mass and the desired external wrench {W_{R}}, plus each \hat{L}ᵢ. This solution may be used for tension optimization control to attempt to ensure active cables remain in tension for pseudostatic motions.

The vehicle simulator system dynamics may be a factor in cable tensioning, especially for simulated vehicle motions with high velocities and accelerations. That is, certain dynamic motions of the vehicle platform may cause higher tensions in some cables and lower tensions (even slack cables (negative tensions)) in other cables than that predicted by the pseudostatic model.

Even for relatively slow pseudostatic vehicle platform motions, not all desired configurations and wrenches may exist with only positive active cable tensions. Even for zero applied Cartesian wrench (i.e. only supporting the weight of the platform and vehicle), the cable tension optimization algorithms may need to consider slack cables (negative tensions), especially for large rotations of the vehicle platform away from the nominal horizontal orientation.

At least two approaches can be used to maintain positive cable tensions on active cables for vehicle platform motion. Both require actuation redundancy, i.e. more active cables than Cartesian dof. The first approach uses an algorithm for spatial motion and three degrees of actuation redundancy (e.g., nine cables for the six Cartesian dof configuration) employing active cable tension control with an optimization method for standard particular/homogeneous solutions. For additional detail on a similar algorithm for planar cable-suspended robots with one degree of actuation redundancy, see Williams II et al., Planar Translational Cable-Direct-Driven Robots, Journal of Robotic Systems, 20(3), pages 107-120 (2003), the contents of which are fully incorporated herein by reference. The second approach specifies and controls known cable tensions in the down-pulling cables and calculates the six unknown upper cable tensions via the standard non-redundant matrix inverse. To provide the known tensions in the down-pulling cables, actual linear springs may be included in line with active cables 7, 8, and 9, converting the tension control problem into an easier length control problem for each of these cables, or active tension control may be provided without physical springs.

Since exemplary nine-cable vehicle simulator system embodiment has actuation redundancy, Equation (9) is underconstrained (six equations in the nine unknown active cable tensions {t}) which means that there are three infinities of solutions. To invert Equation (9) (solving the required cable tensions {t} achieve wrench {W_{R}−G}) the well-known particular and homogeneous solution from rate control of kinematically-redundant serial manipulators may be adapted as follows:

{t}=[S]⁺{W_{R}−G}+([I₉]−[S]⁺[S]){z} (11).

The first term of Equation (11), {t}ₚ=[S]⁺{W_{R}−G}, is the particular solution to achieve the desired wrench. The matrix [S]⁺=[S]^{T}([S][S]^{T})⁻¹ is the 9×6 underconstrained Moore-Penrose pseudoinverse of active statics Jacobian [S]. The second term of Equation (11), {t}ₕ=([I₉]−[S]⁺[S]){z}, is the homogeneous solution, projecting any arbitrary vector {z} into the null space of [S]. [I₉] is the 9×9 identity matrix. Vector {z} can be chosen to ensure positive cable tensions in the nine resulting cables. The homogeneous active cable tension solutions {t}ₕ combine to cause zero wrench on the environment from the vehicle platform (the wrench is supplied only by the particular solution).

MATLAB function lsqnormeg implements a version of Equation (11). It is the least squares solution (minimum norm solution for underconstrained systems of equations such as Equation (9)) subject to only non-negative values on solution components. This is a good function to use for cable-suspended vehicle platforms with the constraint that cables exert positive tensions.

In the solution discussed above, the lower three cable tensions may turn out to be negative, which would require a pushing up to help resist the weight of the platform and vehicle. The homogeneous solution may be used in an attempt to avoid negative cable tensions. However, a simpler approach may be to simply specify positive cable tensions for the three lower cables and determine the required upper six cable tensions for pseudostatic balance. These cable tensions may be time-varying and different from each other depending on motion requirements. They can be provided by physical springs in line with cables 7, 8, and 9, or they

$${[}_{P}^{B} T ] = [ \begin{matrix}0.9513 & - 0.2432 & 0.1897 & 0.2 \\ 0.2549 & 0.9662 & - 0.0394 & 0.6 \\ - 0.1736 & 0.0858 & 0.9811 & 1.5 \\ 0 & 0 & 0 & 1\end{matrix} ] . \qquad ( 15 )$$

The inverse pose kinematics solution (Equation (2)) yielded the following nine active cable lengths (m): L₁=2.1224, L₂=2.1153, L₃=2.8805, L₄=3.0514, L₅=2.5667, L₆=3.0092, L₇=1.3142, L₈=1.7152, and L₉=1.6180. The resulting platform vertices may be expressed as follows:

$$\{ {}_{}^{B}{P}{}_{1}^{} \} = \{ \begin{matrix}0.6054 \\ 1.0064 \\ 1.4380\end{matrix} \} , \{ {}_{}^{B}{P}{}_{2}^{} \} = \{ \begin{matrix}- 0.3458 \\ 0.7515 \\ 1.6116\end{matrix} \} , \\ \{ {}_{}^{B}{P}{}_{3}^{} \} = \{ \begin{matrix}0.3404 \\ 0.0422 \\ 1.4504\end{matrix} \} , \{ {}_{}^{B}{P}{}_{4}^{} \} = \{ \begin{matrix}0.1621 \\ 0.6079 \\ 1.3038\end{matrix} \} . \qquad ( 16 )$$

To hold the vehicle simulator system in static equilibrium the required cable tensions from the particular solution (the first term of Equation (11)) are given on the left in Equation (17). Since the lower three cables require negative cable tensions from the particular solution, it is not used directly. Specifying a 50 N positive cable tension for each of cables 7, 8, and 9, positive cable tensions can be obtained using Equation (13) as given on the right in the equation below:

$$\{ t \} = \{ \begin{matrix}123.10 \\ 122.02 \\ 165.68 \\ 154.91 \\ 207.18 \\ 97.07 \\ - 237.14 \\ - 143.07 \\ - 164.19\end{matrix} \} \{ t \} = \{ \begin{matrix}{t}_{16} \\ {t}_{79}\end{matrix} \} = \{ \begin{matrix}408.00 \\ 439.76 \\ 216.85 \\ 186.81 \\ 381.99 \\ 173.33 \\ 50 \\ 50 \\ 50\end{matrix} \} . \qquad ( 17 )$$

Given the nine active cable lengths (m): L₁=2.1224, L₂=2.1153, L₃=2.8805, L₄=3.0514, L₅=2.5667, L₆=3.0092, L₇=1.3142, L₈=1.7152, and L₉=1.6180, the assignment is to calculate the resulting pose of the vehicle platform with respect to the base, [_{P}^{B}T]. The forward pose kinematics solution yielded the same solution as the input of the inverse pose kinematics problem from Equation (15). may be achieved through active tension control of these cables. The equations to accomplish this cable tensioning method are provided below.

First, Equation (9) may be partitioned as follows:

[S₁₆]{t₁₆}+[S₇₉]{t₇₉}={W_{R}−G} (12),

where [S₁₆] is the first six columns of [S], [S₇₉] is the last three columns of [S], {t₁₆} is the unknown vector of upper cable tensions 1 through 6, and {t₇₉} is the specified vector of cable tensions 7 through 9 (the three down-pulling cables). Then, the unknowns {t₁₆} can be solved using the standard square matrix inverse:

{t₁₆}=[S₁₆]⁻¹({W_{R}−G}−[S₇₉]{t₇₉}) (13).

Equation (13) can be combined with the specified values for {t₇₉} to form a valid solution to Equation (9) with positive cable tensions, assuming {t₇₉} were specified to be positive and the vehicle platform orientation does not rotate too far from nominal.

For the examples described herein, the following vehicle simulator system parameters were used. Of course, numerous combinations of adjustments to these parameters are possible. The upper ceiling-mounted fixed-base cable connection points may be on the vertices of an equilateral triangle with side 4 m. The vehicle platform cable-connection vertices may be on an equilateral triangle of side 1 m. The down-pulling cables may be secured to the vehicle platform at the triangle centroid, 0.2 m below the plane of the triangle. The lower floor-mounted fixed-based cable connection points may be on an equilateral triangle of side 1 m. The floor-to-ceiling height may be 3 in. The platform mass may be assumed to be 100 kg and the platform CG may be assumed to be the same as the platform control point P (i.e., the centroid of the platform equilateral triangle).

Given the desired pose of the vehicle platform with respect to the base in terms of position vector and Z-Y-X, Euler angles may be expressed as follows:

$${ }^{B} {X}_{T} = \{ \begin{matrix}x \\ y \\ z \\ α \\ β \\ γ\end{matrix} \} = \{ \begin{matrix}0.2 \\ 0.6 \\ 1.5 \\ 15 \\ 10 \\ 5\end{matrix} \} ( m and deg ) . \qquad ( 14 )$$

The assignment is to calculate the associated active cable lengths and cable tensions. The associated input homogeneous transformation may be calculated as follows:

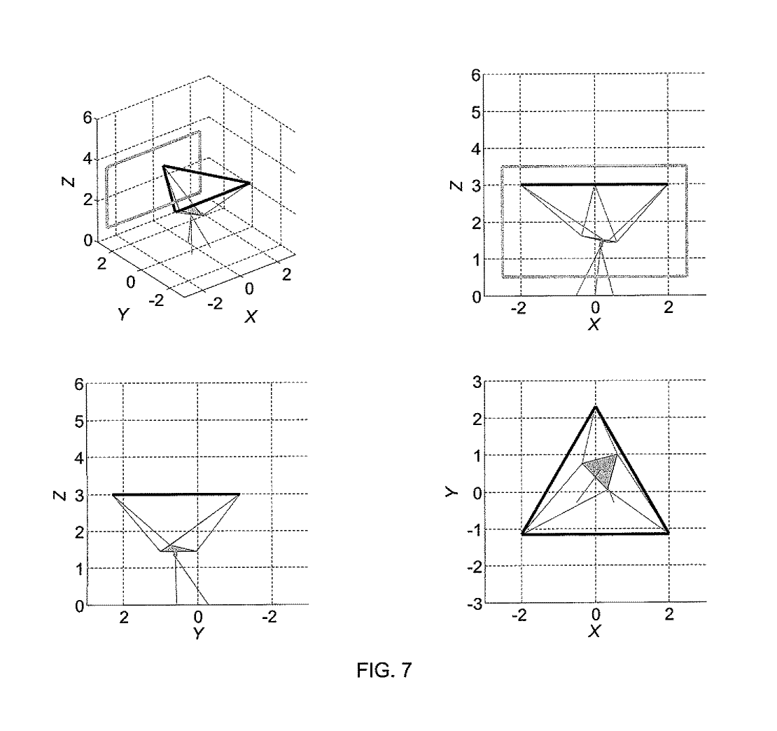

The vehicle platform cable-connection points may be the same as those listed above. The pseudostatic cable tensions may also be the same as those listed above. The graphical vehicle simulator system poses for these snapshot examples are shown in FIG. 7.

An inverse-pose-based trajectory example can be used to command general sine waves with independent amplitudes and frequencies on each of the six Cartesian motions (i.e., three translations and three rotations). More specifically, the simulated vehicle simulator system may be requested to move in a sine wave in the Z direction with 1 m amplitude and 1 rad/s frequency while simultaneously rotating about the Z axis with a sine wave of 30 deg amplitude and 2 rad/s frequency, from an initial pose. An exemplary representation of an initial pose is provided below:

$${ }^{B} {X}_{T} = \{ \begin{matrix}x \\ y \\ z \\ α \\ β \\ γ\end{matrix} \} = \{ \begin{matrix}0 \\ 0 \\ 1.5 \\ 0 \\ 0 \\ 0\end{matrix} \} . \qquad ( 18 )$$

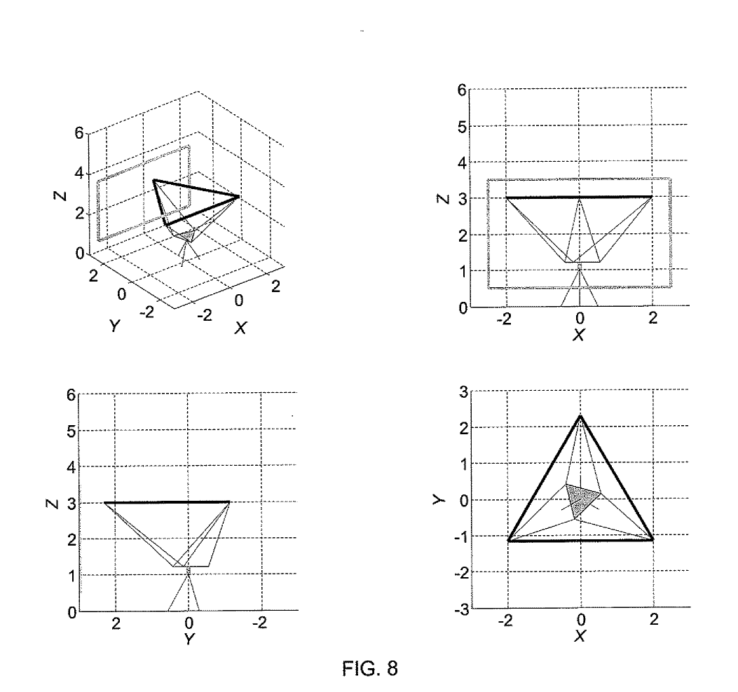

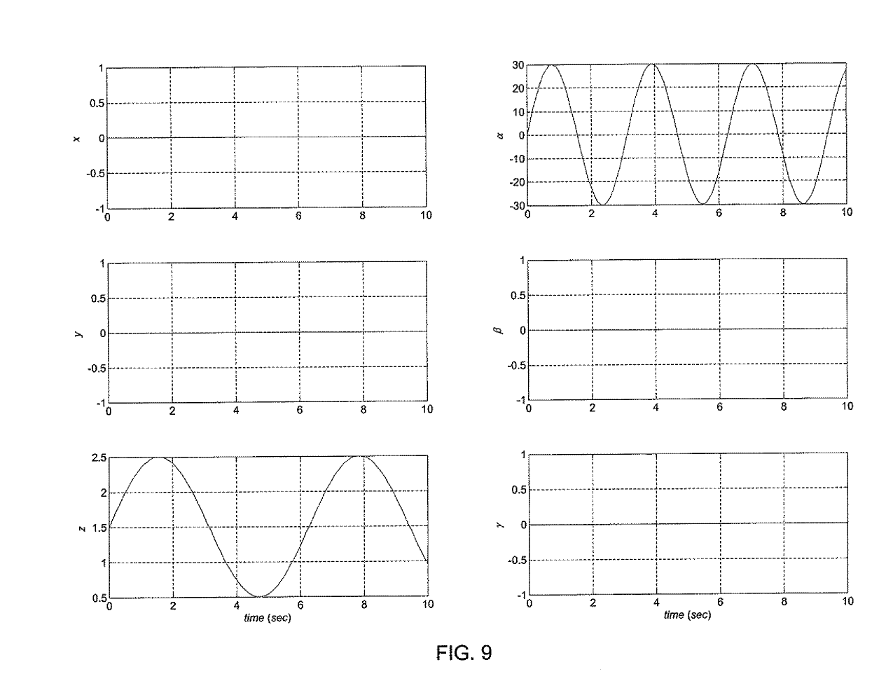

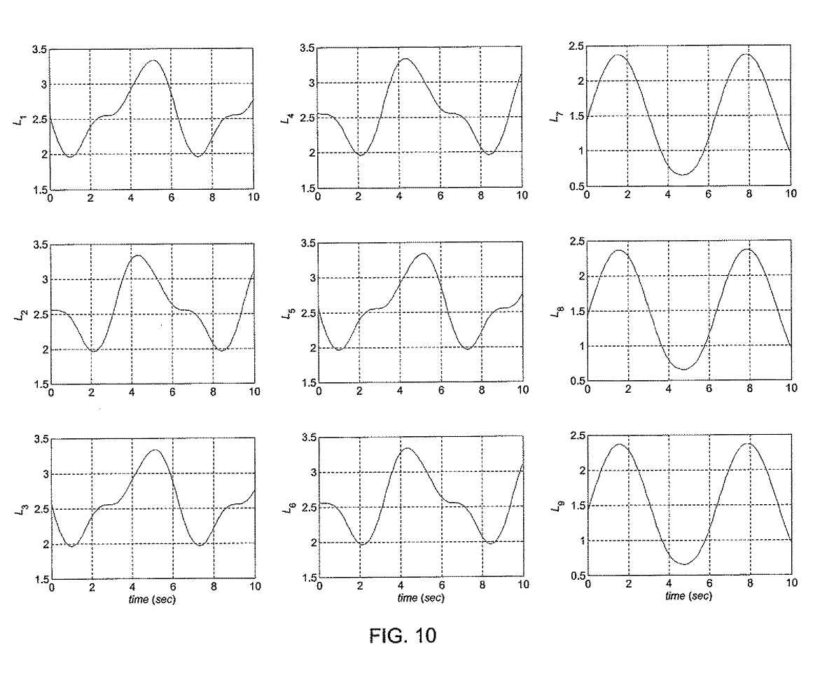

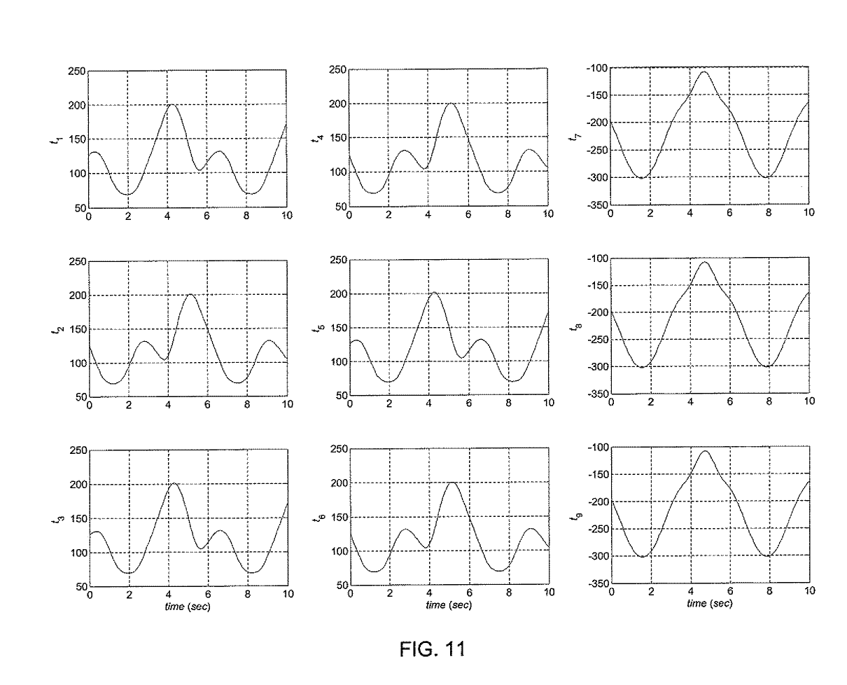

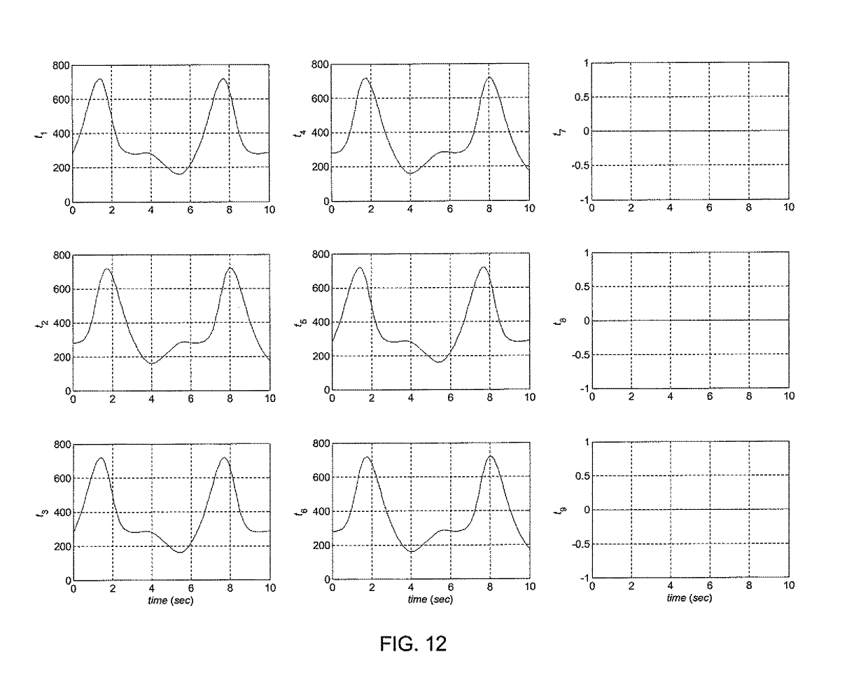

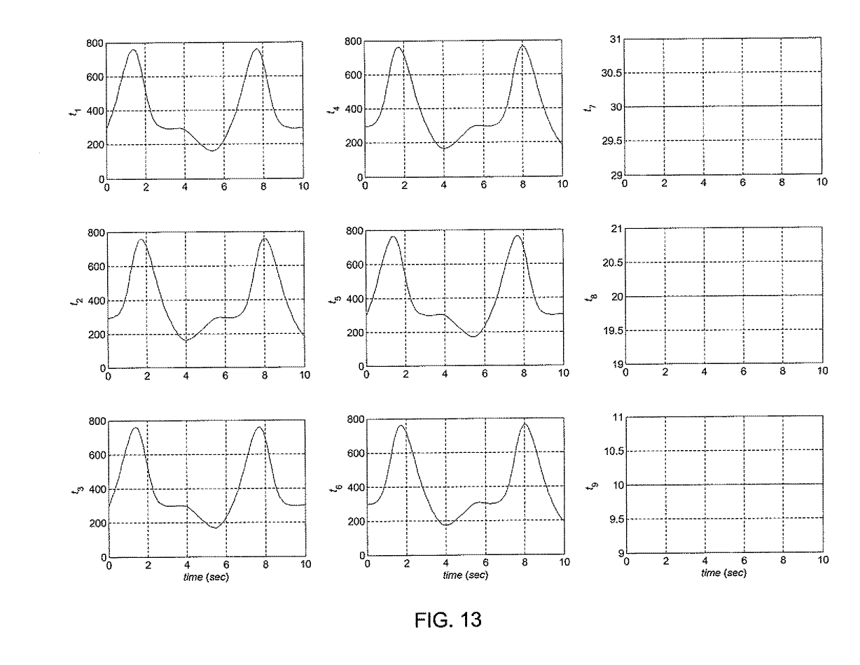

This motion may be simulated for 10 sec; FIG. 8 shows a motion snapshot at t=6.0 sec. For this trajectory example: FIG. 9 shows the commanded Cartesian pose; FIG. 10 shows the required cable lengths as calculated by the inverse pose kinematics solution at each time step; FIG. 11 shows the nine active cable tensions calculated via the particular solution component of Equation (11); FIG. 12 shows the nine active cable tensions calculated via the complete solution Equation (11) implemented by MATLAB function lsqnormeg; and FIG. 13 shows the nine active cable tensions calculated by specifying positive cable tensions of 30, 20, and 10 N for the lower three cables 7, 8, and 9, respectively, and using Equation (13).

FIG. 9 shows the exemplary commanded (and, simulated, achieved) Cartesian motions from the initial pose: a sine wave in the Z direction with 1 m amplitude and 1 rad/s frequency plus rotating about the Z axis with a sine wave of 30 deg amplitude and 2 rad/s frequency. FIG. 10 shows the exemplary required cable lengths to achieve this motion, calculated from the inverse pose kinematics solutions. Due to the special symmetry in motion (pure vertical translation and only yaw, no pitch or roll), there is special symmetry in the cable length solutions: cable lengths 1, 3, and 5 are the same, cable lengths 2, 4, and 6 are the same, and cable lengths 7, 8, and 9 are the same, all of which make sense from the arrangement of cables in the vehicle simulator system.

For this simulated motion, FIG. 11 shows the cable tensions calculated by the particular solution of Equation (11). These tensions are not realistic because the lower three down-pulling cables have negative tensions (cables 7, 8, and 9) and would be up-pushing cables. FIGS. 12 and 13 present attempts to correct this problem. FIG. 12 shows the results of MATLAB function lsqnormeg over the commanded trajectory. As shown, the lower cable tensions turn out to be zero for all motion (the minimum allowable tension values) and all six upper cables have significantly higher tensions than the previous results of FIG. 11. In FIG. 13, Equation (13) is used by enforcing constant positive values for cable tensions 7, 8, and 9 of 30, 20, and 10 N, respectively. These results are not greatly different from those of FIG. 12; all upper cable tensions are somewhat greater over the entire simulated motion. Notably, if zero cable tensions are specified for the lower cables 7, 8, and 9 using Equation (13), the results from Equation (13) are the same as the MATLAB function lsqnormeg shown in FIG. 12.

In summary, a concept for a cable-suspended vehicle simulator system (see FIG. 4) is provided herein. The system may simulate the dynamics of a wide variety of real-world vehicles using VR immersion. For example, ‘driving’ from a realistic vehicle (e.g., cockpit) may be simulated with realistic input devices, possibly providing force feedback, while the system provides motions to one or more human occupants that are designed to mimic real-world motions. This may be termed whole-body haptics (e.g., a human occupant rides in the cable-suspended vehicle). Other exemplary applications for the vehicle simulator system include vehicle (e.g., aircraft, truck, etc.) operator training, vehicle research and development, gaming and entertainment (to enable active participation), and rehabilitation and therapy.

The vehicle simulator system (see FIG. 4) may improve upon existing Stewart platform-based flight simulations (see FIGS. 1 and 2). For example, the system may be lighter, stiffer, have higher accelerations, and have lower cost, while being adaptable to simulate a larger range of vehicles. This is supported by the concepts, kinematics and pseudostatics equations, and simulated motion examples described above.

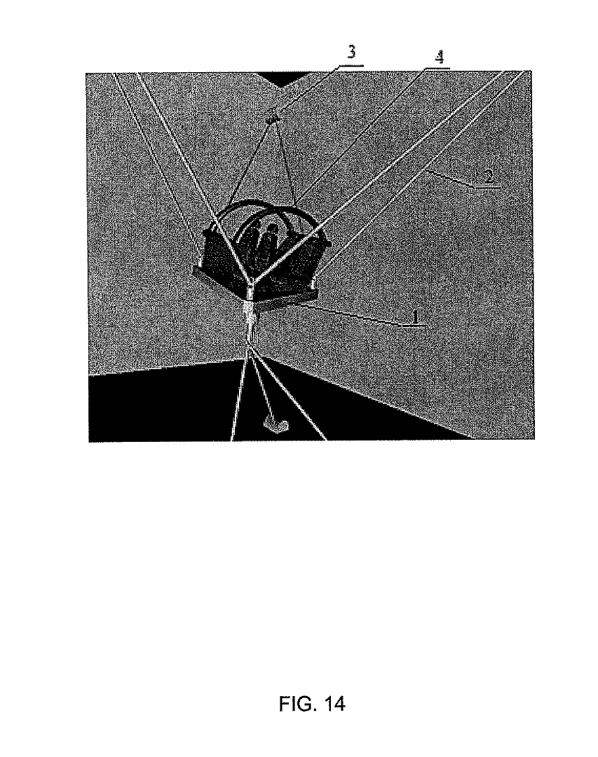

With reference to FIG. 14, a vehicle simulator system may include a cable-suspended platform and a vehicle mounted thereon that may be used, for example, for pilot and driver training. The vehicle simulator system may provide realistic, VR simulations to one or more human occupants of a vehicle in conjunction with movement of cable-suspended vehicle platform. A method for producing inertial forces that act on the vehicle platform, vehicle, and human occupant is provided herein. A detailed description of the vehicle platform's dynamics constraints is also provided below, as well as an exemplary numerical solution. Using the exemplary mathematical model, the vehicle platform workspace may be analyzed, as well as the influence of the vehicle platform orientation angle ranges on the available workspace, to show that the model may be used for algorithms to control motion of the vehicle platform for simulations. Vehicle platform motion may be controlled, for example, through four control systems in a form of a cascade control with a fuzzy logic controller in outer loops. The cable-suspended vehicle platform may be non-linear and may be difficult from a classical control point of view, since it may require local linearization of the dynamics equations. The fuzzy logic control concept may be used to control the vehicle platform position, velocity and acceleration and, for simulations, may be allied with inner-loop classical control. In one exemplary embodiment, the system is under-constrained, with nine unknown cable tensions and six dynamics equations, and an optimization method may be used. The control complexity may be increased if maintaining positive cable tensions is required. Exemplary vehicle simulations may be modeled using a VR environment.

Flight simulators have been in use since the 1960s, generally including a heavy, hydraulically-driven octahedral hexapod Stewart platform or a variant thereof (see FIGS. 1 and 2). The cable-suspended vehicle platform of the vehicle simulator system replaces the Stewart platform with a lighter, more economical, cable-suspended motion system with a lower payload-to-weight ratio. The real-world cockpits of a variety of vehicles may be used in VR simulations with realistic vehicle motion in the vehicle simulator system. For example, aircraft, automotive, mountain biking, horseback riding, kayaking, surfing, skiing, or other types of real world experiences may be provided as VR simulations with the vehicle simulator system. Usher et al., A Cable-Array Robot for Air Vehicle Simulation, Proceedings of the Australian Conference on Robotics and Automation, Can berra, Australia (Dec. 6-8, 2004), describes a cable-suspended robot that may be used to aid in controls development for an autonomous helicopter. Additionally, Marshall, Aerial Cable Range, Aberdeen Proving Ground, Maryland (2007), identifies a three-mile-long cable that may be used for unmanned air vehicle (UAV) operator training. The contents of each of the documents identified in this paragraph are fully incorporated herein by reference.

First-time experience with an aircraft or a helicopter can be stressful due to high inertial forces acting on pilots. Use of a simulator for pilots training is a regular practice. Such simulators already exist in the form of octahedral hexapod robot structures with hydraulic actuators. However, the cable-suspended vehicle platform in the vehicle simulator system (FIG. 14) in place of an octahedral hexapod motion system with hydraulic actuators. Simulations in the vehicle simulator system may be termed as whole-body haptics, wherein one or more human occupants ride in a realistic vehicle (e.g., cockpit) and feels realistic inertial forces of motion associated with the simulation.

The cable-suspended vehicle platform exhibits a higher external load/vehicle platform weight ratio with lower inertial forces acting on the vehicle platform structure and may obtain higher vehicle platform accelerations due to the relatively low mass of the vehicle platform structure than hydraulic octahedral hexapod motion systems. However, control of the cable-suspended vehicle platform may require certain considerations because a cable cannot transfer compression forces. Moreover, additional consideration may be required because the cable-suspended vehicle platform may be a highly non-linear object.

Previous cable robot research, which is related to use of the cable-suspended vehicle platform in the vehicle simulator system, is related to determination of a cable robot workspace for various static loads of end-effectors. For example, an analytical approach to define the workspace for a robot with six cables, loaded with an arbitrary wrench acting on the end-effector, is given in Bosscher et al., Wrench-Feasible Workspace Generation for Cable-Driven Robots, IEEE Transactions on Robotics, 22(5), pages 890-902, (2006). Other analyses of cable robot workspace are done by developing the governing equations analytically and then solving them numerically. For additional information on these analyses, see So-Ryeok et al., Generation of Feasible Set Points and Control of a Cable Robot, IEEE Transactions on Robotics, 22(3), pages 551-558 (2006), and Pusey et al., Design and Workspace Analysis of a 6-6 Cable-Suspended Parallel Robot, Elsevier: Mechanism and Machine Theory, 39, pages 761-778 (2004). The contents of each of the documents identified in this paragraph are fully incorporated herein by reference.

In general, the vehicle platform of the cable vehicle simulator system has six degrees of freedom for 3D motion or three degrees of freedom for planar (i.e., two-dimensional (2D)) motion. This means that it is possible to establish six differential equations (or algebraic equations, if a pseudo-static case is considered) in the 3D case or three equations in the 2D case. On the other hand, a cable-suspended vehicle platform can have an arbitrary number of cables and each cable introduces a new unknown variable that may be determined by a dynamics analysis. To obtain a solution in a case that there are more unknown cable tensions than dynamics equations, some kind of optimization method may be applied. For additional information on these methods, see Williams II et al., 3D Cable-Based Cartesian Metrology System, Journal of Robotic Systems, 21(5), pages 237-257 (2004); Park et al., Wire-Suspended Dynamical System Stability Analysis by Tension-Closure, IEEE Transactions on Robotics, 21(3), pages 298-308 (2005); and Williams II et al., Translational Planar Cable-Direct-Driven Robots, Journal of Intelligent and Robotic Systems, 37, pages 69-96 (2003). The contents of each of the documents identified in this paragraph are fully incorporated herein by reference.

A particular task of a cable-suspended vehicle platform may utilize a particular type of motion defined in Cartesian coordinates with specified position and orientation, velocity, or acceleration of the vehicle platform. However, the variables that can be directly controlled are cable tensions, via controlling torques of motors that retract (i.e., wind) or extend (i.e., unwind) corresponding cables from reels to which the cables are connected. For additional information on cable-suspended vehicle platform control using a classical feedback control approach, see Yingjie et al., Feedback Control of a Cable-Driven Gough-Stewart Platform, IEEE Transactions on Robotics, 22(1), pages 198-202 (2006) and So-Ryeok et al., A Reference Governor-Based Controller for a Cable Robot Under Input Constraints, IEEE Transactions on Control Systems Technology, 13(4), pages 639-645 (2006). The contents of each of the documents identified in this paragraph are fully incorporated herein by reference.

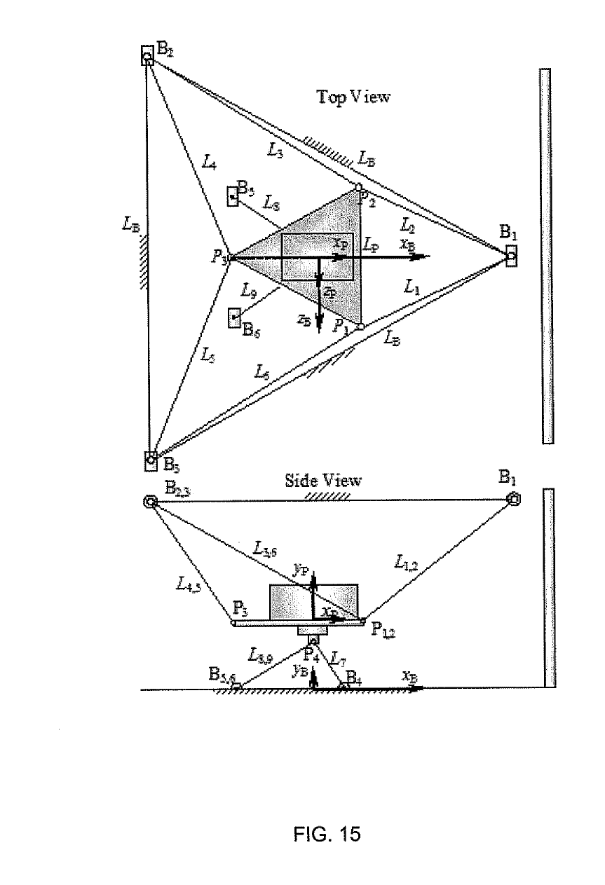

With reference to FIG. 15, top and side views of an exemplary embodiment of the whole-body haptics vehicle simulator system (VSS) are shown. The 6-dof (xyz translations, roll-pitch-yaw rotations) motion for the one or more human occupants is imparted using the ceiling-mounted six-cable-suspended vehicle platform. In another embodiment, the six cables may be suspended from walls, poles, or another type of support structure. Rotation of the vehicle platform may be limited, similar to a octahedral hexapod Stewart-Gough platform, but the translational 6-dof workspace can be quite large. Motors and cable reels, for example, may be fixed to the ceiling and floor and the cable ends may be secured to the platform carrying the vehicle. The system bandwidth and accelerations allow for a variety of simulations for a variety of vehicles. The vehicle may include an operator compartment (e.g., cockpit, truck cab, etc.) a passenger compartment, or a combination of both from a real vehicle (i.e., as it looks in the real world), insofar as possible, including real input, indicator, and display devices for realism. The real devices may be augmented for realistic simulation. For example, the devices may include haptic (force-feedback) input devices, such as haptic flight sticks or haptic driving wheels. Alternatively, the vehicle be a simulated replica of the real vehicle or any of combination of the devices may be simulated replicas of the corresponding real devices. As shown in FIGS. 14 and 15, the cable vehicle simulator system may be a modified NIST RoboCrane (see FIG. 3) adapted to carry a vehicle and control motion for the vehicle platform for realistic, VR simulations. For example, the NIST RoboCrane design may be adapted to include three cables pulling down from the floor of the vehicle platform (see FIGS. 14 and 15) for crisper downward motions. In the embodiment being described, the system does not simply rely on gravity for downward accelerations, thus downward accelerations larger than g can be achieved. For example, the optional down-pulling cables adapt the gravity-constrained NIST RoboCrane design to a fully constrained cable-suspended vehicle platform.

The vehicle platform, for example, may have a 100 kg mass and may have an equilateral triangular shape. The platform may bear a vehicle (e.g., cockpit) together with a (i.e., one or more occupants (e.g., pilot, driver, passenger, etc.) and necessary equipment for manual and automatic control to simulate various vehicle motions. The system may include nine cables (e.g., steel cables) of a suitable size (e.g., 10 mm) that are secured to the vehicle platform and motor-controlled actuators (e.g., motor-driven cable reels). The vehicle simulator system may include nine motors (e.g., electrical DC motors) to move and position the platform by pulling and releasing the cables from corresponding cable reels. Six actuators may be positioned in pairs at corners of an equilateral triangle (e.g., four meter sides) with six corresponding cables extending downward defining upper limits of a workspace for the vehicle platform. Three additional actuators may be positioned at corners of an equilateral triangle (e.g., one meter sides) with cables generally extending upward defining lower limits of the workspace. The vehicle (e.g., cockpit) may provide seats for the one or more occupants with safety equipment and equipment (e.g., sensors, controls, indicators, displays, etc.) for measurement, manual control, and automatic control of the platform motion. Protection of occupants and equipment on the vehicle platform from cable interference may be taken into account when controlling movement the platform. A projection screen (e.g., 4×3 meters) may be positioned in relation to the vehicle to show a realistic video of scenes resulting from motion of the vehicle through a particular environment (e.g., terrain and objects seen while: i) driving a car along a road; ii) taking off, landing, or flying an airplane; iii) operating a helicopter; or iv) operating another type of vehicle).

Coordinated control of the motors can increase or decrease the cable lengths to simulate motion of the vehicle through the environment. In this way, the platform can be positioned to desired points and attitudes within the vehicle platform workspace to give the occupants the feeling as if they were actually moving through the environment in a simulated scenario. By controlling cable velocities, desired Cartesian vectors of linear and angular platform velocity can be provided at desired times in relation to the simulated scenario. Along with velocity control, desired angular and linear accelerations of the vehicle platform can be provided at desired times in relation to the simulated scenario.

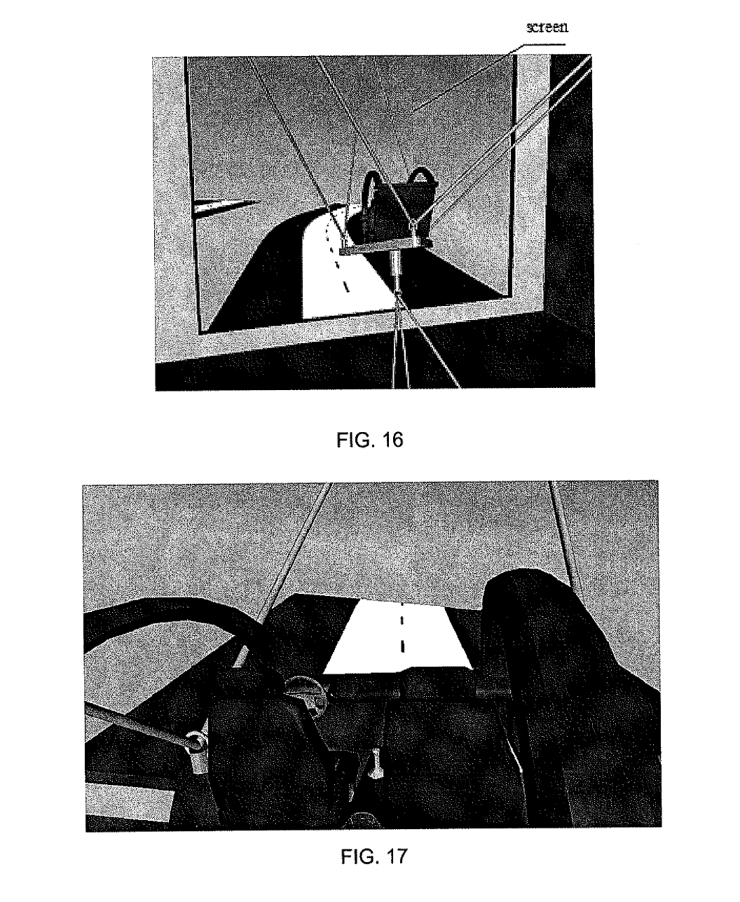

In one embodiment, the vehicle simulator system provides a projection screen in front of the vehicle platform (FIG. 16) and simulates motion through a desired environment to the occupant (e.g., pilot/driver) of the vehicle (e.g., cockpit) using proper visual effects and simultaneously producing inertial forces acting on the occupant that are proportional to those that would appear in real motion through that particular environment. Coordinated control of video and motion, for example, may enhance the realism of the simulated experience (e.g., operator training).

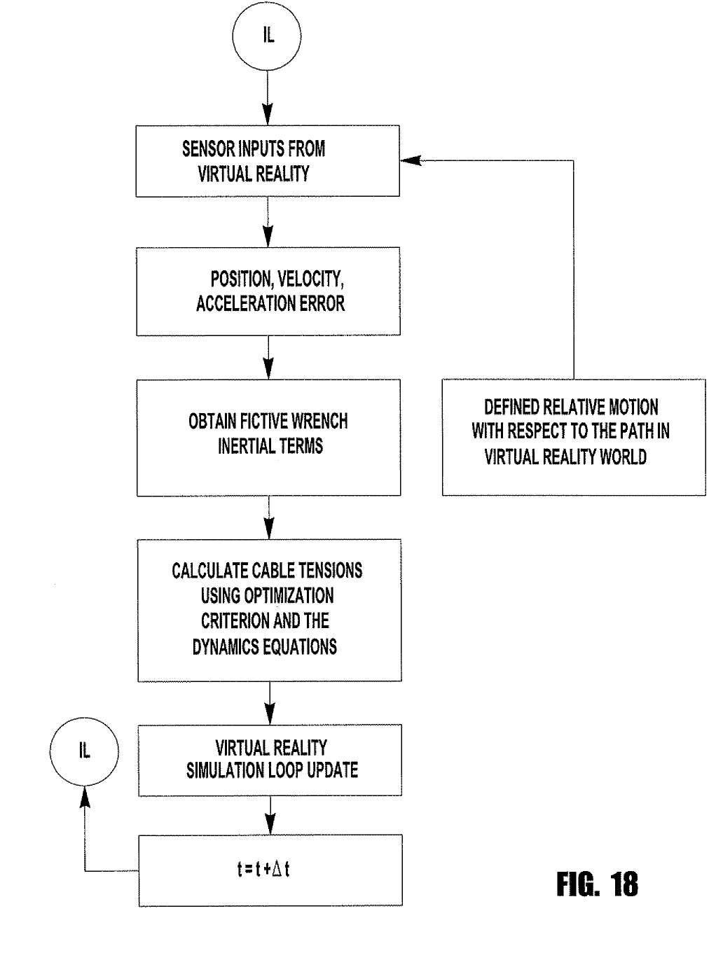

The inertial forces on the occupant (e.g., driver) resulting from proper movement of the vehicle platform make the simulation more realistic. For example, to simulate a jet aircraft scenario, the vehicle simulator system may produce very high acceleration perpendicular to the motion path. Due to the limited workspace of the system, acceleration in a particular direction is time limited. However, existing simulation methods can be used to provide realistic perceptions of continued advancement through the environment. FIG. 17 shows an exemplary view of the projection screen from the vehicle (e.g., cockpit) during a VR vehicle simulation with motion.

Exemplary forward and inverse kinematics equations for the vehicle simulator system are described above. A control system that provides adequate motion of the vehicle platform corresponding to the simulated video on the projection screen may be based at least in part on derived vehicle platform dynamics equations.

The vehicle simulator system may be used in at least two types of simulations: i) passive and ii) active (i.e., interactive). In passive simulations, the occupant (e.g., trainee or user) may enjoy realistic motion while watching a realistic corresponding graphical (e.g., video) presentation based on pre-planned or canned movement within an environment. This method may be useful, for example, during early training stages or for passive entertainment. In active simulations, the occupant (e.g., trainee or user) may use an input device (e.g., flight stick or steering wheel) to select desired movement through the environment and, in response, the system causes the vehicle platform to move in a manner that results in the occupant feeling the dynamics of the vehicle control actions for more meaningful real-world training in the VR environment.

In either mode, the view of the simulated environment on the projection screen changes in relation to the simulated vehicle motion. For example, under either passive or active simulations, the view provided on the projection screen may be automatically adjusted as if it were from the perspective of a virtual camera mounted to the simulated vehicle. Alternatively, the view may could be from a perspective within the vehicle (e.g., the occupant's eye-point) for increased realism. In another embodiment, the perspective within the vehicle for the view could also be adjusted in response to head movement by an occupant.

As described above, the vehicle platform of the cable vehicle simulator system may have six Cartesian degrees of freedom, so six differential equations may describe the dynamics of the platform. Newton's Second Law gives three differential equations and the angular momentum rate of change law gives an additional three differential equations. A more detailed derivation of these six equations is given below. The set of differential equations can be expressed in the following matrix form:

$$A \ddot{x} + B \dot{x} = \{ \begin{matrix}{F}_{R} \\ {M}_{R}\end{matrix} \} \\ where \\ A = {[ \begin{matrix}m \cdot {1}_{3 \times 3} & - m {{}_{2}^{0}{R}{}_{}^{2} ( {ρ}_{c} )}^{⊗} \\ {m ( {}_{2}^{0}{R}{}_{}^{2} {ρ}_{c} )}^{⊗} & {}_{2}^{0}{R}{}_{}^{2} {I}_{D ( 3 \times 3 )}\end{matrix} ]}_{6 \times 6} , \\ B = {[ \begin{matrix}{[ 0 ]}_{3 \times 3} & - {m}_{2}^{0} {{R}^{2} ( ω \times {ρ}_{c} )}^{⊗} \\ {[ 0 ]}_{3 \times 3} & - {{}_{2}^{0} R ( {}_{}^{2}{I}{}_{D ( 3 \times 3 )}^{2} ω )}^{⊗}\end{matrix} ]}_{6 \times 6} , \\ [ \begin{matrix}{F}_{R} \\ {M}_{R}\end{matrix} ] = {[ \begin{matrix}{}_{}^{0}{F}{}_{ext}^{} + {m}^{0} g + {\sum }_{( i )} ( - {}_{}^{0}{\hat{L}}{}_{i}^{} ) {t}_{i} \\ \begin{matrix}{}_{}^{0}{M}{}_{ext}^{} + {}^{0} ( {b}_{M} \times {F}_{ext} ) + \\ {\sum }_{( i )} {}_{}^{0}{b}{}_{i}^{} \times ( - {}_{}^{0}{\hat{L}}{}_{i}^{} ) {t}_{i} + {}_{}^{0}{ρ}{}_{c}^{} \times m {}^{0} g\end{matrix}\end{matrix} ]}_{6 \times 1} , , \qquad ( 19 )$$

and
vector \dot{x}=[\dot{x}_{D} \dot{y}_{D} ż_{D} ωₓ₂ ω_{y2} ω_{z2}]^{T} is the velocity vector, or in a symbolic form

$$\dot{x} = [ \begin{matrix}{}_{}^{0}{\vec{v}}{}_{D}^{} \\ {}^{2} \vec{ω}\end{matrix} ] ,$$

m is the platform mass, 1_{3×3} denotes a 3×3 identity matrix, ²I_{D(3×3}) denotes the 3×3 platform inertia matrix, the symbol [symbol]
denotes the matrix form of the cross product, ₂⁰R denotes the rotational matrix giving the orientation of the vehicle platform frame {2} with respect to the world frame {0}, and F_{R} and M_{R} are the resultant force and moment vectors acting externally on the vehicle platform.

A suitable way to solve the set of the vehicle simulator system dynamics equations is to use the numerical solver of Matlab. A complex set of dynamics equations can be solved by the Matlab SimMechanics toolbox. Therefore, the set of the vehicle simulator system dynamics equations may also has be solved using SimMechanics combined with additional programming in m-files. An exemplary embodiment of an iterative procedure for solving the cable-suspended vehicle platform equations is shown in FIG. 18.

The dynamics equations and the numerical approach for their solution have been used to analyze the vehicle platform workspace. The workspace of the vehicle simulator system is defined as a set of points in 3D space that the vehicle platform center of gravity can reach undergoing any positive cable tension combinations with maximum cable tension less than a certain predefined value. The maximum value may be expressed as follows:

$${max}_{i} {t}_{i} < {t}_{allowed} , \qquad ( 20 )$$

where t_{allowed} is the maximum allowed cable tension considering, for example, limitations associated with motor torque and cable strength. The cable tensions depend on static forces, such as weight, and inertial forces:

tᵢ=tᵢ^{static}+tᵢ^{dynamic} (21).

While cable tensions due to static forces depend on the vehicle simulator system position and orientation, cable tensions due to inertial forces depend on vehicle platform motion through the workspace as well as the vehicle simulator system position and orientation. If inertial forces are negligible with respect to static forces (e.g., tᵢ^{static}>>tᵢ^{dynamic}), the workspace of exemplary embodiments of hybrid fuzzy logic/classical controllers for side acceleration/roll angle control and also for longitudinal/pitch angle control.

Fuzzy logic control shows suitable performance for vehicle simulations. In one embodiment, the fuzzy logic controller can be combined in a cascade fashion with a classical control loop controller. The hybrid controller may alleviate certain discontinuities in the fuzzy logic controller output and may reduce the complexity of the controller, for example, by reducing the number of if-then rules or the number of input variables.

In another embodiment, neural network controllers may be implemented to increase processing speed. However, stability may be reduced for this embodiment.

A dynamics and kinematics analysis of the vehicle platform was provided above to demonstrate the validity of certain specifications for exemplary control systems. The results of the workspace analysis provided above show that the size of the cable-suspended vehicle platform workspace may be influenced by the platform angle change. For example, allowing angles to change within interval [−20°, 20°] may reduce the workspace by approximately 66%. The available size of the cable-suspended vehicle platform workspace may also be influenced by inertial forces acting on the vehicle platform.

Beside the constraints on angles change, limitations may also be established for rates of change of cable lengths. A modeling phase may be used to identify undesirable negative or high cable tensions before a simulation scenario is actually run on the vehicle simulation system.

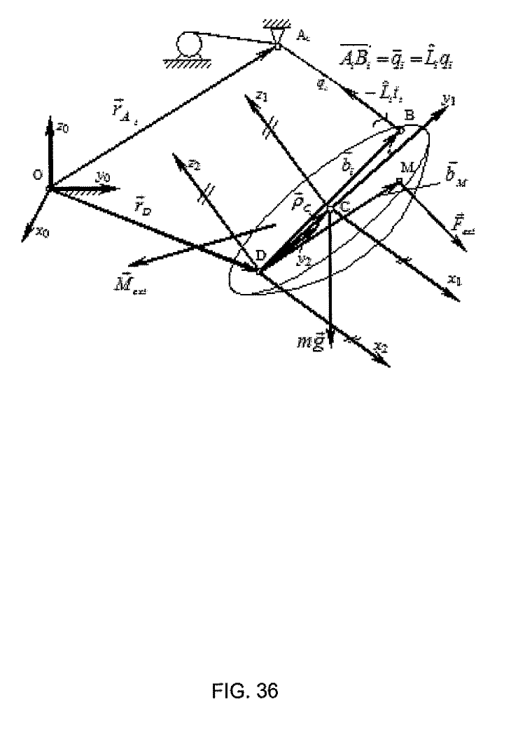

FIG. 36 shows a free-body diagram for an exemplary vehicle simulator system. As shown, the moving coordinate frame may be secured to a point different than the center of gravity (i.e., mass).

Newton's second law expressed in the coordinate frame {0} gives:

$$m {\vec{a}}_{c} = m \vec{g} + {\sum }_{( i )} ( - {\hat{L}}_{i} ) {t}_{i} + {\vec{F}}_{ext} , \qquad ( 26 )$$

where \hat{L}ᵢ is the unit vector with direction of the i^{th} cable (from point Aᵢ to point Bᵢ), tᵢ is the i^{th} cable tension, \vec{F}ₑₓₜ is the external force. Acceleration of the center of gravity may be evaluated using the acceleration of point D:

⁰\vec{α}_{C}=⁰\vec{α}_{D}+⁰(\vec{α}×\vec{ρ}_{C})+⁰\vec{ω}×⁰(\vec{ω}×\vec{ρ}_{C}) (27),

or in the following expression:
the vehicle platform can be uniquely determined in 3D space. Otherwise, the workspace depends on vehicle platform trajectories, i.e., a radius of curvature, velocity and acceleration, and may not be uniquely defined as a function of 3D coordinates. One approach to solving this problem of workspace determination is to analyze the workspace due to static forces and then, if the inertial forces contribution significance, analyze them separately.

As used herein, the term pseudostatic is refers to when cable tensions are analyzed for the vehicle platform in motion, from a point to a point perspective, for static forces, but not inertial forces. Using the right-hand side of Equation (19), and setting the left hand-side of the equation equal to zero, an equation for calculation of the cable tensions due to static load of the vehicle platform can be obtained:

$${[ \begin{matrix}{}_{}^{0}{F}{}_{ext}^{} + m {}^{0} g + {\sum }_{( i )} ( - {}_{}^{0}{\hat{L}}{}_{i}^{} ) {t}_{i} \\ {}_{}^{1}{M}{}_{ext}^{} + {}^{1} ( {b}_{M} \times {F}_{ext} ) + {\sum }_{( i )} {}_{}^{1}{b}{}_{i}^{} \times ( - {}_{}^{1}{\hat{L}}{}_{i}^{} ) {t}_{i}\end{matrix} ]}_{6 \times 1} = [ \begin{matrix}0 \\ 0 \\ 0 \\ 0 \\ 0 \\ 0\end{matrix} ] . \qquad ( 22 )$$

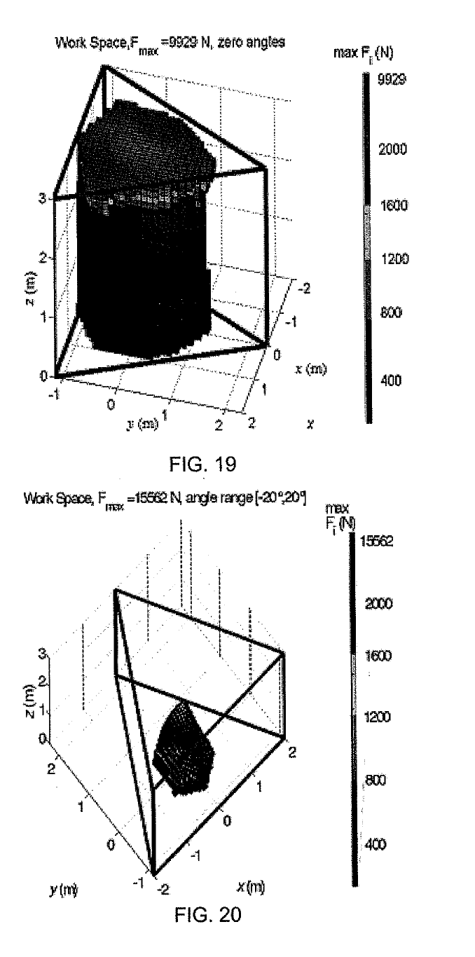

In order to determine the vehicle simulator system pseudostatic workspace, Equation (22) may be solved numerically for the cable tensions at a number of finite workspace volume pieces. Based on Equation (22) and the optimization method that produces a minimum sum of positive cable tensions, the results are shown in FIG. 19.

With reference to FIG. 19, the 3D domain divided into finite volume pieces is the prismatic space denoted by the edge lines of the prism with the ceiling triangular base. It can be noted that the maximum cable tensions appear when the platform approaches the top level triangular base. In this plane, six motors are planar with the platform and the theoretical value for the cable tensions is infinite.

The prismatic space that was considered is not filled completely in FIG. 19. This means that wherever there is no marked box the cable tensions has maximum value greater than a predefined value, in this case 9929 N, or there is no combination of positive cable tensions that will keep the platform at a given position and orientation. This analysis considers translation of the vehicle simulator system platform without rotation. In other words, rotation angles are presumed zero.

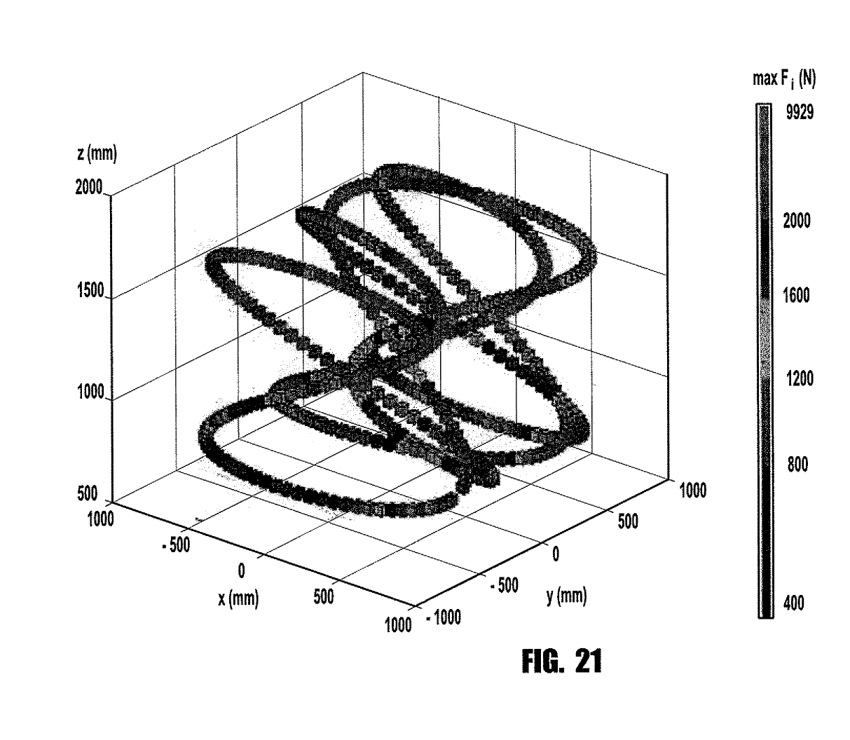

The next case (FIG. 20) takes into account translation and rotation of the vehicle platform and calculations of the maximum cable tension allowing the rotation angles (three Euler's angles) within the range ±20°. FIG. 20 shows that the workspace is significantly reduced if rotation angles in the range [−20°, +20°] are allowed on all three axes. The workspace determination is done similarly to the previous case. However, in this case the angle range for all three angles is divided into a number of finite pieces also. The maximum cable tension at each position is calculated for each combination of the three angles within the range [−20°, +20°]. If the overall cable tension for possible combinations is less than predefined limiting cable tension, then that position in 3D domain is considered as a part of the workspace, otherwise it is not including in the workspace. Further increase of the allowed rotation angles rapidly reduces the workspace size.

The workspace determination is important in order to limit planned vehicle platform trajectories onto the feasible pseudostatic workspace and to avoid high cable tensions that could be unsafe and damaging. If a planned vehicle platform trajectory is a subset of pseudostatic workspace and the inertial forces are not significant with respect to static forces, then cable tensions will be limited by a predefined maximum value.

Next, it is shown that platform orientation in the pseudo-static workspace can influence cable tensions. If even a relatively small angle range of rotation is allowed, there is a significant workspace reduction. It has been shown that for the range [−20°, 20°] the reduction of the workspace is about ⅔. The significance of inertial forces on the cable tensions and workspace distortion is discussed below.

The cable-suspended vehicle platform trajectory can contain a number of segments that have small radii of curvature. Passing through those segments, the platform may undergo high inertial forces. These inertial forces, in general, can reduce the effective cable-suspended vehicle platform workspace. The influence of the inertial forces is shown in FIG. 21, for translational-only trajectories within the pseudostatic workspace of FIG. 19. The grayscale color ranging from 2000 to 9929 N denotes the segments of the path with the highest cable tensions.

The analysis of the available cable-suspended vehicle platform workspace is necessary to make appropriate control design specifications and to constrain the control goals discussed below.

Cable-suspended vehicle platform control provides a specified position and orientation of the vehicle platform with respect to time in order to properly coordinate control with other subsystems (e.g., video) for the simulation scenario. Additionally, cable-suspended vehicle platform control provides control of the vehicle platform acceleration in two directions and two angular accelerations about those two directions. The cable-suspended vehicle platform control must accommodate the fact that a cable cannot push a body. Moreover, cable-suspended vehicle platform control must also accommodate non-linear kinematics and dynamics equations. The position, velocity and acceleration of the platform is specified in the Cartesian coordinate system, but the directly-controlled and directly-sensed variables are cable lengths. Indirectly controlled outputs are three positions of the platform center of gravity and three angles of the platform. This indirect control requires a non-linear transformation of coordinates.

When a classical control algorithm is applied, a local linearization is applied at each time step. This linearization process may cause control errors, depending on the amount of non-linearity of variables trajectories, the time step, and magnitudes of the velocity and acceleration. In one embodiment, classical control algorithms may be applied in combination with Fuzzy logic control algorithms for control of the cable-suspended vehicle platform. In another embodiment, a neural network controller may be implemented.

Fuzzy logic control concepts have been shown to be successful in the area of non-linear systems control. For additional information on such fuzzy logic control concepts, see Avdagic, Artificial Intelligence and Fuzzy-Neuro-Genetic Algorithms, Grafoart, Sarajevo (language: Bosnian) (2003), the contents of which are fully incorporated herein by reference. One disadvantage of this concept is high requirement for processing power that rapidly rises with the number of the fuzzy rules used by the control algorithm. In another embodiment, neural network control algorithms may be implemented in the vehicle platform control to reduce the processing power required by certain fuzzy rules. An exemplary controller architecture combining fuzzy logic control with classical control loops is discussed in more detail below.

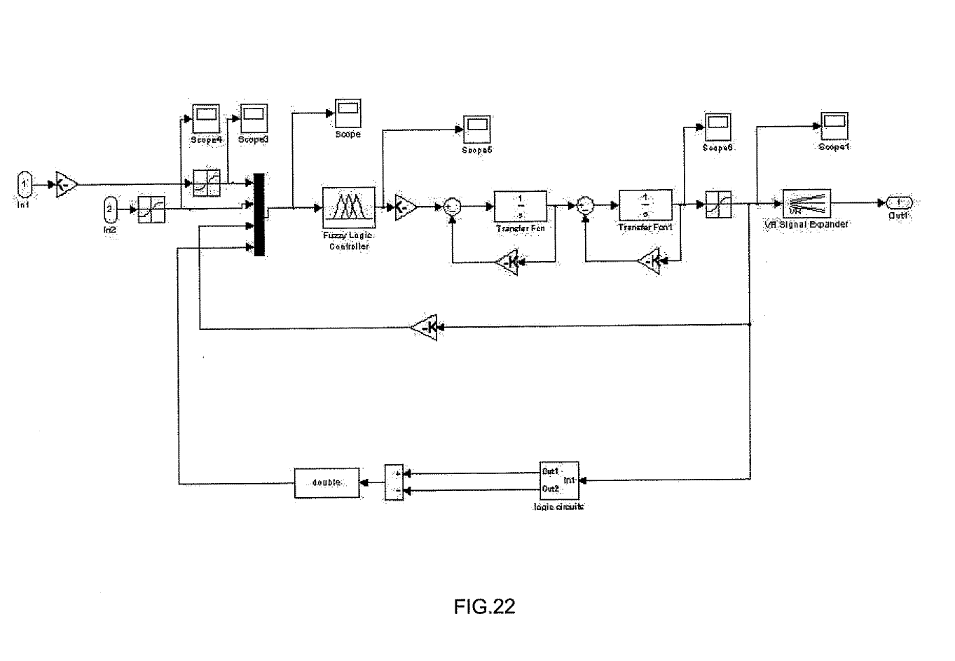

In order to produce certain inertial forces that may be sensed by an occupant (e.g., user) of the vehicle in the vehicle simulator system, side acceleration of the vehicle platform may be controlled. FIG. 22 shows a Matlab/Simulink realization model of an exemplary side acceleration control system.

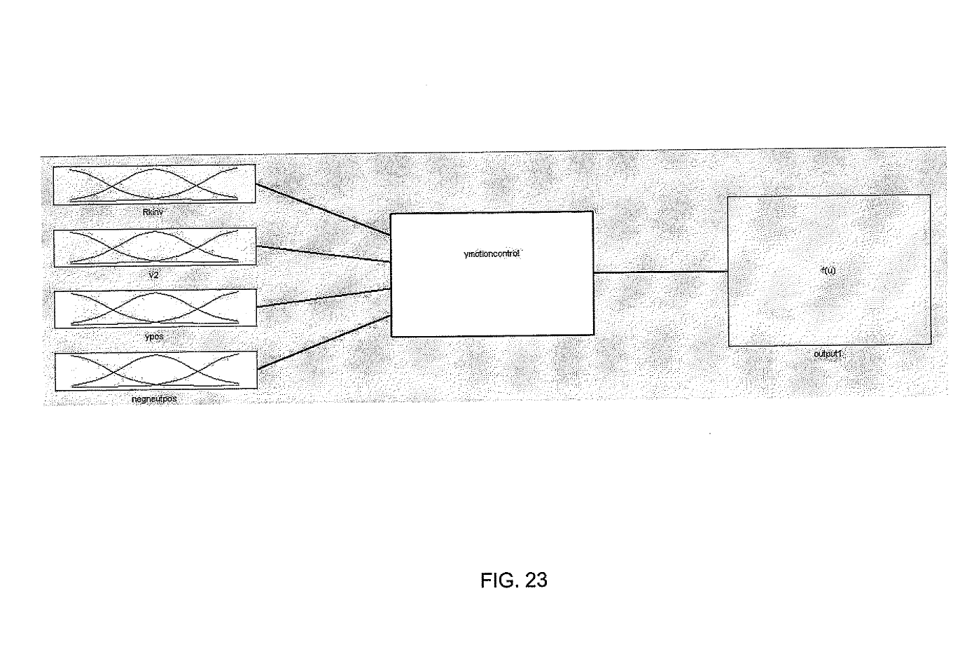

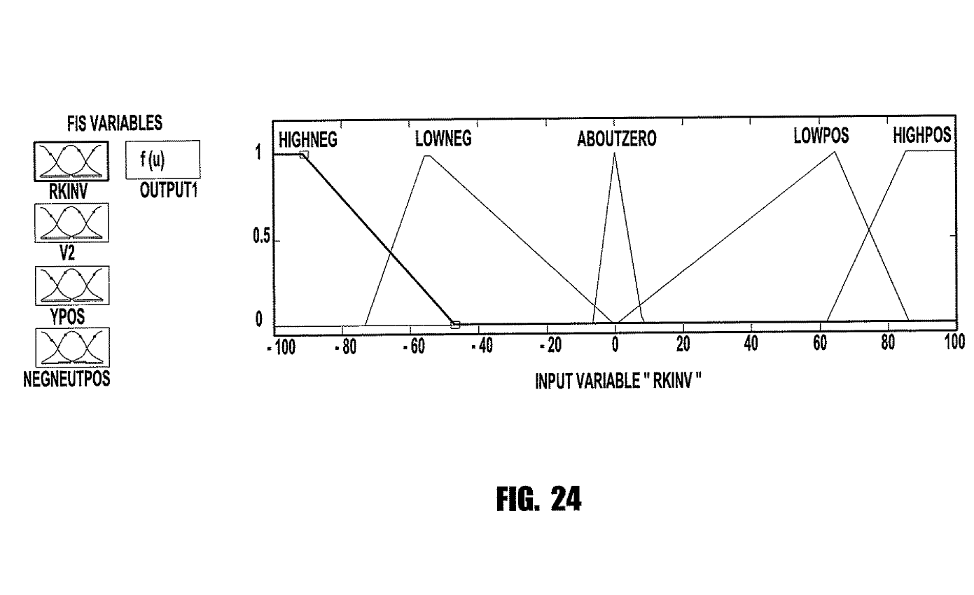

The side acceleration control loop is an exemplary foam of a cascade control and may include a fuzzy logic controller and a classical control loop. The main (outer) control loop may include the fuzzy logic controller. An exemplary embodiment of the internal structure of the controller for the main (outer) control loop is shown in FIG. 23. Each input variable to the controller may be associated with five membership functions. Membership functions for the first input variable are shown in FIG. 24. As shown, inputs to the controller may include: i) radius of the desired trajectory “Rkinv”, ii) current side position of the robot “ypos,” and iii) an additional input that bears the information on whether a boundary is reached.

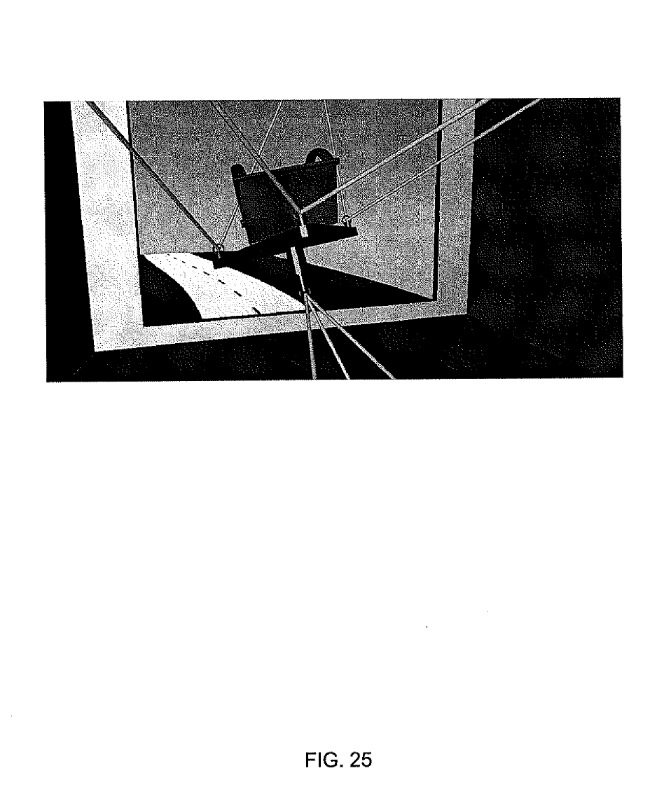

The radius of curvature of a path may become infinitely high for straight segments. In order to eliminate appearance of high values of this input variable, the inverse of the radius may be used. Membership functions associated with this input (i.e., “Rkinv”) may include: i) highly negative (trapezoidal form), ii) low negative (triangular form), iii) about zero (triangular form), iv) low positive (triangular form), and v) highly positive (trapezoidal form). The second variable (the Cartesian feedback from the output) may be associated with five membership functions in similar fashion as for the radius of the curvature. Results from simulation scenarios show suitable performance for this cascade control. FIG. 25 shows an instant of the simulation scenario during a side acceleration of the platform.

Once consideration of the side acceleration control is the limited space of the cable-suspended vehicle platform motion. A side acceleration of significant duration may be required for various vehicle simulation trajectories. The vehicle simulator system can produce this acceleration for the vehicle platform within its limited workspace. When a boundary is approached, the controller may slowly (e.g., below the human occupant's capacity for detection) return the vehicle platform to the neutral position while maintaining the required side acceleration.

To make the simulation more realistic to an occupant (e.g., user), an additional effect may be introduced, such as a roll angle change to complement the side acceleration of the vehicle platform.

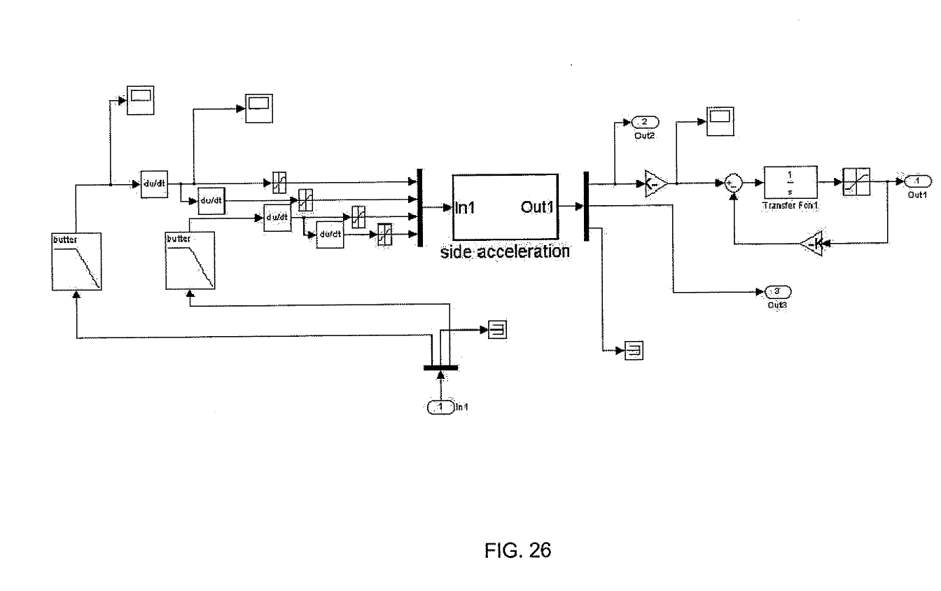

In order to alleviate the influence of high inertial forces onto the occupant (e.g., driver) and to make the simulation more realistic, the roll angle (i.e., rotation about the longitudinal axis) may be changed in such a way that the resulting force, consisting of the gravity force and the inertial force vector, acts perpendicularly to the seat. Similarly, an aircraft may change its direction of motion with a change of the roll angle toward the center of the curvature. An exemplary control loop for the roll angle is shown in FIG. 26.

The controller may change the roll angle depending on the side acceleration of the vehicle platform. Therefore, inputs into the control loop may include the radius of curvature and the velocity of the desired vehicle trajectory. The input signals may include noise, which may cause errors in the derivatives of such signals. The input signals may be filtered and the output signals after differentiation of the input signals may be limited to certain reasonable values to reduce errors due to noise.

FIG. 25 shows an instant of the vehicle simulation with motion during a side acceleration of the platform. For example, if the side acceleration is oriented to the left, the resulting inclination is to the left. Results from simulation scenarios, taking into consideration that the angle range is limited to [−20°, 20°] because the available vehicle platform workspace reduces significantly when increasing the angle beyond this range, show suitable performance for the applied controller.

Besides the side acceleration, the vehicle acceleration can also have a longitudinal component. The control concept of the longitudinal acceleration of the vehicle platform is discussed below.

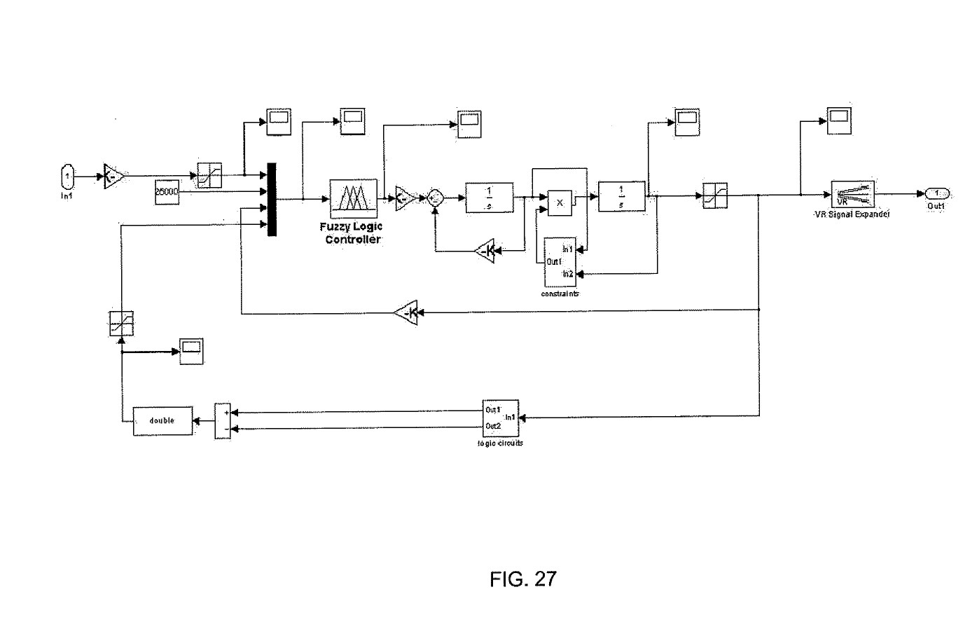

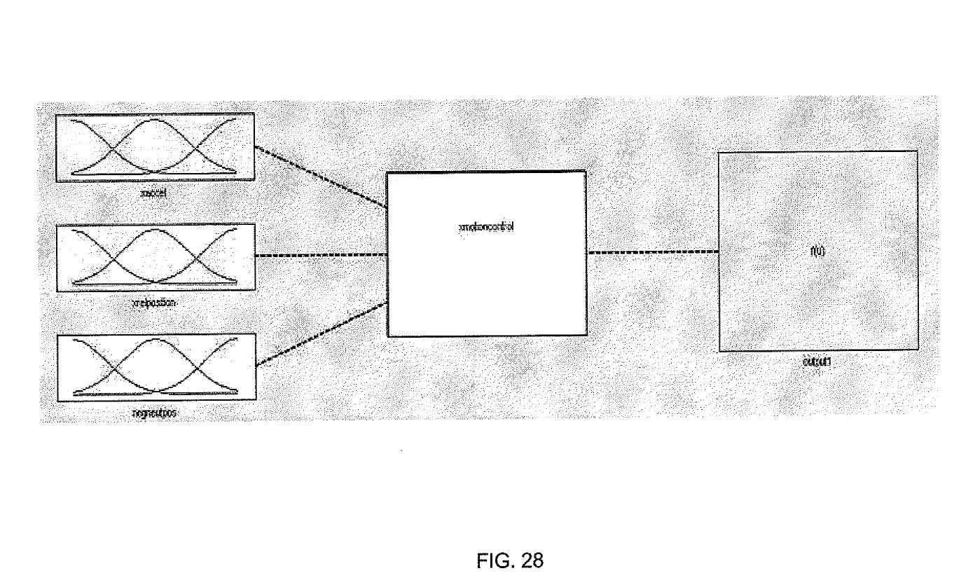

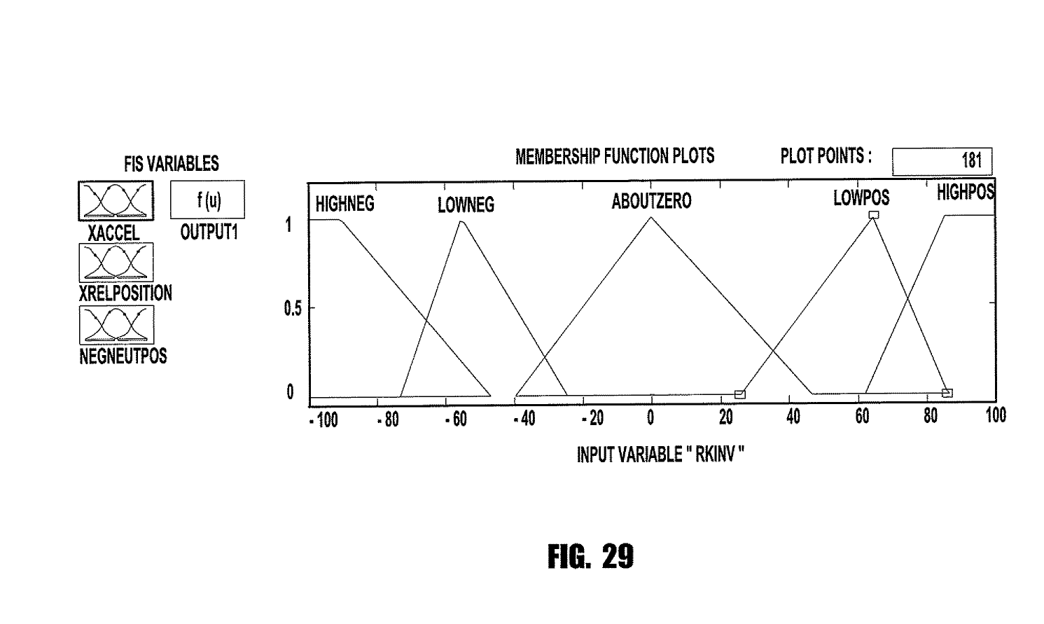

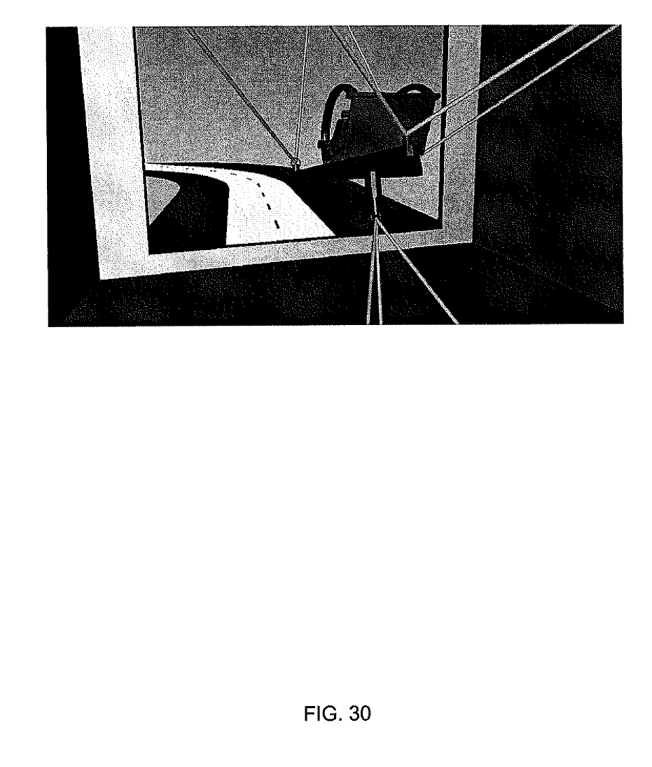

The longitudinal acceleration control may produce longitudinal acceleration of the vehicle platform proportional to the acceleration of the simulated vehicle motion. The control loop for longitudinal acceleration is shown in FIG. 27, with a structure similar to side acceleration control. The cascade control may include a fuzzy logic controller in the outer loop and two inner classical control loops. Input variables may be associated with five membership functions each. The internal structure of the controller for control loops and the membership functions for the first input variable to the controller are shown in FIGS. 28 and 29, respectively. Results from simulation scenarios show suitable performance of this cascade control loop. An instant of the vehicle simulation is shown in FIG. 30.

The control loop for pitch angle control described below shares the same input variable in order to provide adequate pitch angle of the platform.

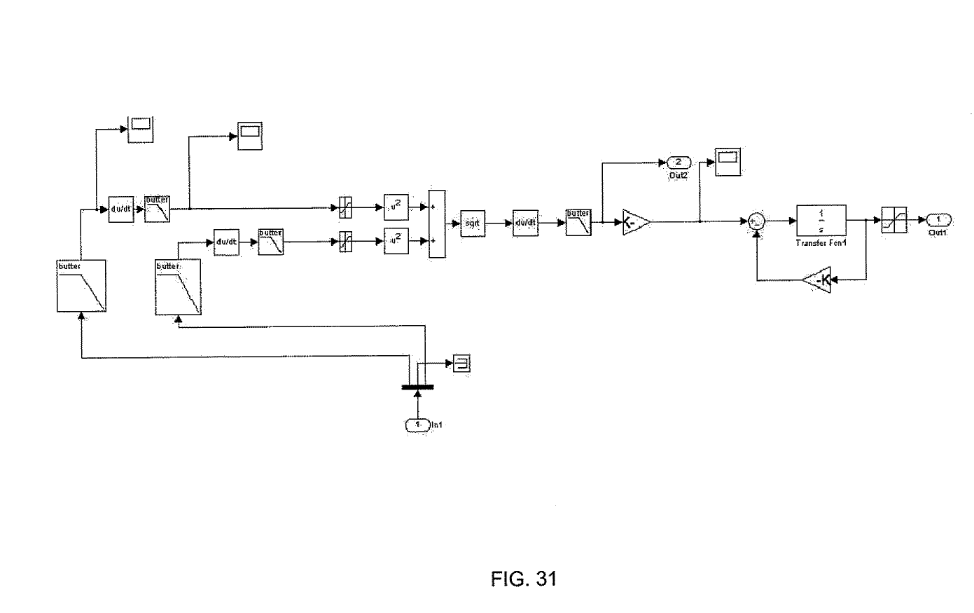

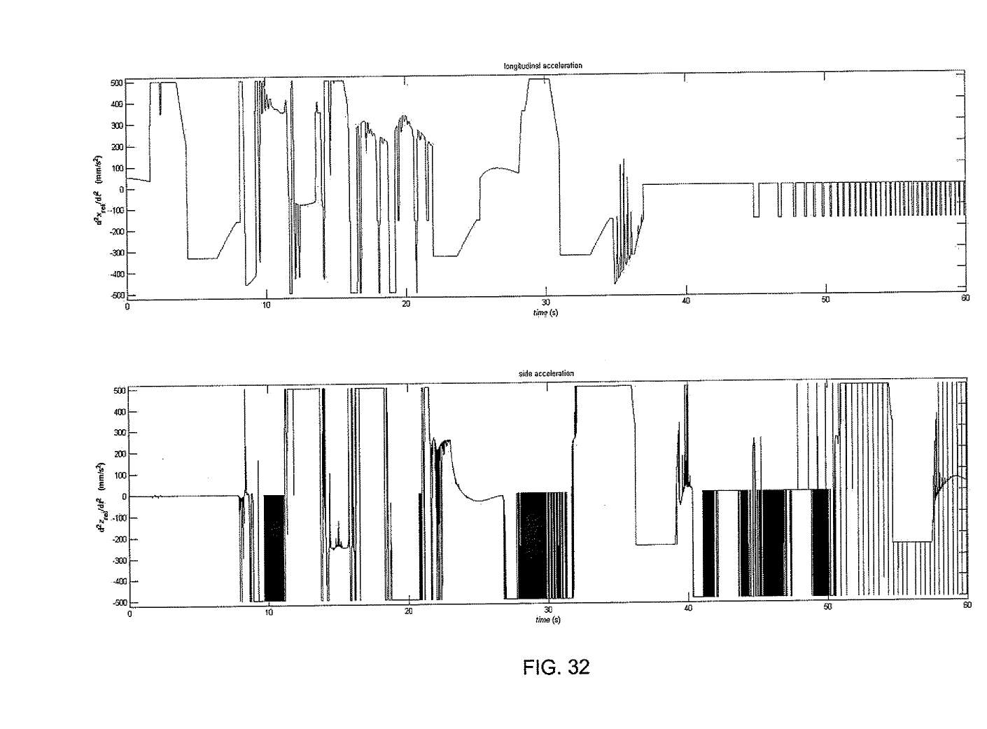

The pitch angle control provides the occupant (e.g., user) with an additional effect that makes longitudinal acceleration realistic. The angle magnitude depends on the magnitude of the tangential acceleration and may be limited to a range of [−20°, 20°] due to limited workspace of the vehicle platform. FIG. 31 shows an exemplary control loop for pitch angle control modeled using Matlab/Simulink. The input signal may bear information about two components of the vehicle velocity (e.g., in the two horizontal directions). Noise may again cause problems with differentiation of the input signal. The input signal may be filtered, differentiated, again filtered, and limited to reasonable values to reduce errors due to noise. As shown, classical control may be implemented for pitch angle control. Results of simulation scenarios (e.g., snapshot shown in FIG. 30) show suitable performance of this type of pitch angle control.

A method for maintaining positive cable tensions for all commanded motions is provided below. The dynamic equations can be used to calculate cable tensions tᵢ (i=1, . . . , 9) necessary to produce a desired (known) acceleration of the platform. This under-constrained set of equations can be written in the following form:

Jac_{6×9}·t_{9×1}=d_{6×1} (23).

To close the set of equations, a new set of constraints that ensure a minimization of the norm may be expressed:

∥Jac_{6×9}·t_{9×1}−d₆₋₁∥ (24),

in the following form:

$$\frac{\partial }{\partial {t}_{i}} ‖ {Jac}_{6 \times 9} \cdot {t}_{9 \times 1} - {d}_{6 \times 1} ‖ = 0 , i = 1 , … , 9. \qquad ( 25 )$$

Additional constraints, in the form of inequalities tᵢ≧0, i=1, . . . , 9, may ensure that calculated values for the cable tensions are positive. Equation (25) can be solved numerically through an iterative procedure, without finding analytical expression for the derivatives. In a case where a vehicle platform crosses a boundary of the available vehicle platform workspace, two potential problem situations may appear: i) there may be no solution for Equation (25) without negative calculated cable tensions or ii) some calculated cable tensions may be higher than the specifications for available or practical cable materials or motors (e.g., maximum motor torque).

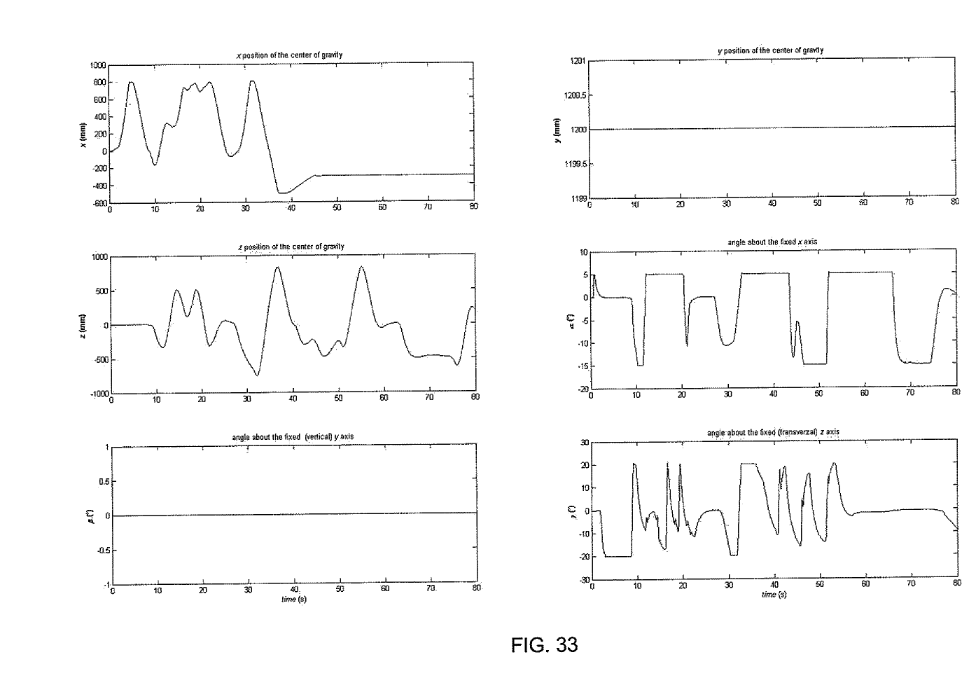

An exemplary embodiment of the vehicle simulator system control with side acceleration/roll angle control combined with longitudinal acceleration/pitch angle control for an exemplary simulated automotive vehicle motion scenario is provided below. Exemplary filtered acceleration commands the control system embodiment and simulation scenario being described are shown in FIG. 32.

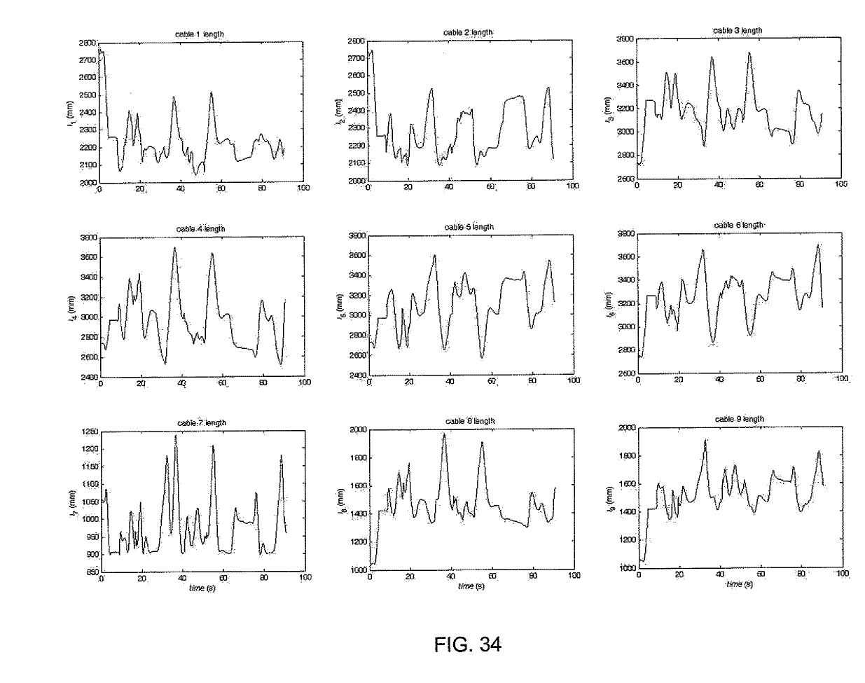

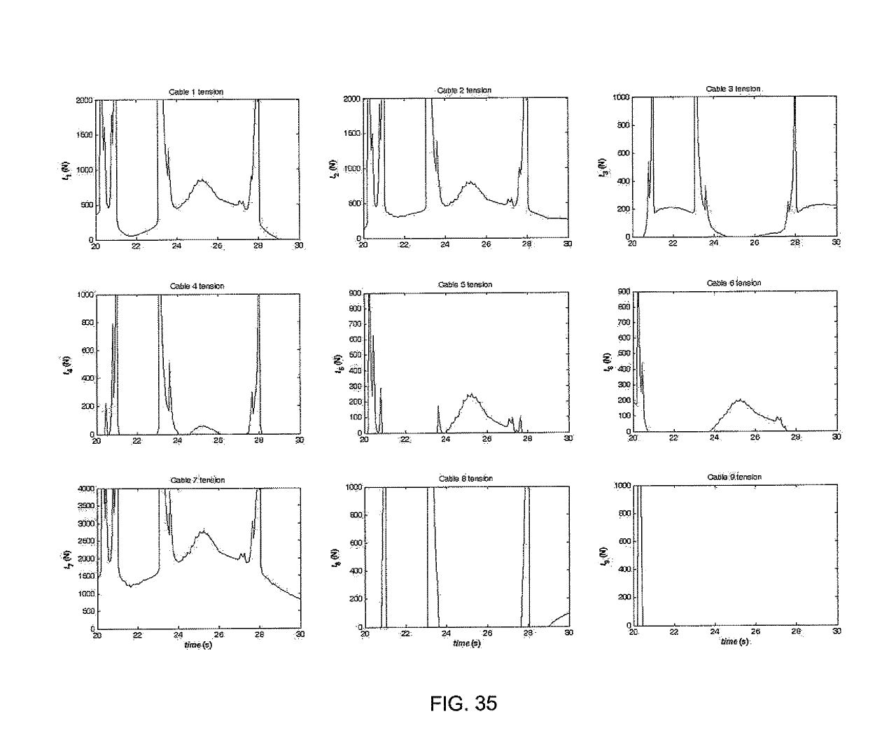

FIG. 33 shows six Cartesian motion variables for the control system embodiment and simulation scenario being described. FIG. 34 shows cable lengths for the control system embodiment and simulation scenario being described. FIG. 35 shows the associated cable tensions for the control system embodiment and simulation scenario being described. The base and platform Cartesian coordinate frames, plus the cable numbering convention, for the control system embodiment and simulation scenario being described are shown in FIG. 15. The three Cartesian angles α, β, and γ are rotations about the fixed X_{B}, Y_{B}, and Z_{B} axes, respectively.

The fuzzy logic controller for longitudinal acceleration may provide a signal with relatively high magnitude at the beginning of a simulation interval (e.g., scenario) and after achieving a certain velocity of the simulated vehicle, the signal may attenuate. The fuzzy logic controller for side acceleration may change the output signal frequently in certain intervals. However, the output signal may be filtered before its application. A second level of filtering may be accomplished the controlled object (e.g., the vehicle platform may act as an integrator block).

During the simulation, the pitch angle may be limited to [−15°, 15°] and the roll angle may be limited to [−20°, 20°] in order to avoid reduction of the available vehicle platform workspace. The vehicle platform height may be fixed to 1200 mm. The yaw angle may be set to zero, for example, depending on the nature of motion for the vehicle being simulated.

FIGS. 34 and 35 show examples of times when a sharp change in a cable length results in corresponding high value for cable tension. This may limit the desired path and motion for a realistic VR approach. For example, a desired motion for a simulation scenario may be created and written in a software program and may describe unfeasible or impractical motion due to high cable tensions and possibly attempting to move the vehicle platform outside the available workspace. Crossing the workspace boundaries may cause drop in control performance and may damage the system. These problems may be avoided by using a modeling phase to test simulation scenarios before they are run on vehicle simulation system.

In summary, various embodiments of a cable-suspended vehicle simulator system and a method for performing a simulation scenario are provided herein. Derivation of nonlinear dynamics equations associated with the system and method and a vehicle platform workspace associated with the system and method are described herein. Matlab/Simulink/SimMechanics/VR toolbox simulations were performed to demonstrate

$${}_{}^{0}{\vec{a}}{}_{C}^{} = {}_{}^{0}{\vec{a}}{}_{D}^{} + ( - {}_{}^{0}{( {\vec{ρ}}_{C} )}{}_{}^{⊗} ) \cdot {}^{0} \dot{\vec{ω}} + ( - {}_{}^{0}{( \vec{ω} \times {\vec{ρ}}_{C} )}{}_{}^{⊗} ) \cdot {}^{0} \vec{ω} , \qquad ( 28 )$$

where the superscript 0 denotes that a vector is expressed within coordinate frame {0} and the symbol

[symbol]

denotes the matrix form of the cross product. The angular momentum rate of change law expressed in coordinate frame {1} gives:

$$\frac{d}{d t} {\vec{H}}_{C} = {\vec{M}}_{ext} + ( {\vec{b}}_{M} - {\vec{ρ}}_{C} ) \times {\vec{F}}_{ext} + {\sum }_{( i )} ( {\vec{b}}_{i} - {\vec{ρ}}_{c} ) \times ( - {\hat{L}}_{i} ) {t}_{i} . \qquad ( 29 )$$

The left hand-side of Equation (29) can be expressed in the following form:

$$\begin{matrix}\frac{d}{d t} {}_{}^{1}{\vec{H}}{}_{C}^{} = {\underbrace{( \frac{d}{d t} \vert {\vec{H}}_{C} \vert ) \frac{{}_{}^{1}{\vec{H}}{}_{C}^{}}{\vert {\vec{H}}_{C} \vert}}}_{\begin{matrix}rate of change in intensity \\ multiplied with unit vector\end{matrix} } + {\underbrace{( {}^{1} \vec{ω} \times {}_{}^{1}{\vec{H}}{}_{C}^{} )}}_{result of a direction change} \\ = {}_{}^{1}{I}{}_{C}^{} {}^{1} \vec{\dot{ω}} + {}^{1} \vec{ω} \times ( {}_{}^{1}{I}{}_{C}^{} {}^{1} \vec{ω} ) .\end{matrix} \qquad ( 30 )$$

By inserting Equation (30) into Equation (29) the following can be obtained:

$${}_{}^{1}{I}{}_{C}^{} {}^{1} \vec{\dot{ω}} + {}^{1} \vec{ω} \times ( {}_{}^{1}{I}{}_{C}^{} {}^{1} \vec{ω} ) = {}_{}^{1}{\vec{M}}{}_{ext}^{} + {}^{1} ( {\vec{b}}_{M} - {\vec{ρ}}_{C} ) \times {}_{}^{1}{\vec{F}}{}_{ext}^{} + {\sum }_{( i )} {}^{1} ( {\vec{b}}_{i} - {\vec{ρ}}_{C} ) \times {}^{1} ( - {\hat{L}}_{i} ) {t}_{i} , \qquad ( 31 )$$

where the superscript 1 denotes that a vector or matrix is expressed within coordinate frame {1}. Each term in Equation (31) may be transformed to be expressed within coordinate frame {2}.

The angular momentum change law is valid for center of mass, not for the point D, but we can use D'Alembert's principle to transform those moments onto the point D. The inertial moment \vec{M}^{inert} is:

$$- \frac{d }{d t} {\vec{H}}_{C} = {\vec{M}}^{inert} , \qquad ( 32 )$$

and the inertial force \vec{F}^{inert} is:

−m\vec{a}_{C}=\vec{F}^{inert} (33).

A moment is a free vector, thus the inertial moment can be moved to the point D, but a force produces moment \vec{ρ}_{C}×\vec{F}^{inert}. The equation for rotational motion, expressed in coordinate frame {1}, according to D'Alembert's principle, is:

$${ }_{\_} {{\vec{M}}^{inert}}_{\_} {\vec{ρ}}_{C} \times {\vec{F}}^{inert} = {\vec{M}}_{ext} + {\vec{b}}_{M} \times {\vec{F}}_{ext} + {\sum }_{( i )} {\vec{b}}_{i} \times ( - {\hat{L}}_{i} ) {t}_{i} + {\vec{ρ}}_{C} \times m \vec{g} . \qquad ( 34 )$$

After substitution of the terms in Equation (34) the following expression can be obtained:

$$\begin{matrix}{I}_{C} \vec{\dot{ω}} + \vec{ω} \times ( {I}_{C} \vec{ω} ) + m {\vec{ρ}}_{C} \times ( {\vec{a}}_{D} + \dot{\vec{ω}} \times {\vec{ρ}}_{C} + \vec{ω} \times ( \vec{ω} \times {\vec{ρ}}_{C} ) ) = {\vec{M}}_{ext} + {\vec{b}}_{M} \times {\vec{F}}_{ext} + {\sum }_{( i )} {\vec{b}}_{i} \times ( - {\hat{L}}_{i} ) {t}_{i} + {\vec{ρ}}_{C} \times m \vec{g} , \\ \text{where:} & ( 35 ) , \\ {I}_{C} = {I}_{D} - m [ \begin{matrix}{y}_{1 D}^{2} + {z}_{1 D}^{2} & - {x}_{1 D} {y}_{1 D} & - {x}_{1 D} {z}_{1 D} \\ - {x}_{1 D} {y}_{1 D} & {x}_{1 D}^{2} + {z}_{1 D}^{2} & - {y}_{1 D} {z}_{1 D} \\ - {x}_{1 D} {z}_{1 D} & - {y}_{1 D} {z}_{1 D} & {x}_{1 D}^{2} + {y}_{1 D}^{2}\end{matrix} ] = {I}_{D} - Δ I , & ( 36 ) \\ {\vec{ρ}}_{C} \times ( \dot{\vec{ω}} \times {\vec{ρ}}_{C} ) = \dot{\vec{ω}} ( {ρ}_{C}^{2} ) - {\vec{ρ}}_{C} ( \dot{\vec{ω}} \cdot {\vec{ρ}}_{C} ) , \\ and & ( 37 ) \\ \begin{matrix}{\vec{ρ}}_{C} \times ( \vec{ω} \times ( \vec{ω} \times {\vec{ρ}}_{C} ) ) = {\vec{ρ}}_{C} \times ( \vec{ω} ( \vec{ω} \cdot {\vec{ρ}}_{C} ) - {\vec{ρ}}_{C} ( {ω}^{2} ) ) \\ = ( {\vec{ρ}}_{C} \times \vec{ω} ) ( \vec{ω} \cdot {\vec{ρ}}_{C} ) .\end{matrix} & ( 38 )\end{matrix}$$

After substituting Equations (36)-(38) in Equation (35), the following expression for coordinate frame {2} can be obtained:

$${I}_{D} \vec{\dot{ω}} + \vec{ω} \times ( {I}_{D} \vec{ω} ) + m {\vec{ρ}}_{C} \times {\vec{a}}_{D} = {\vec{M}}_{ext} + {\vec{b}}_{M} \times {\vec{F}}_{ext} + {\sum }_{( i )} {\vec{b}}_{i} \times ( - {\hat{L}}_{i} ) {t}_{i} + {\vec{ρ}}_{C} \times m \vec{g} . \qquad ( 39 )$$

Equations (26) and Equation (39) can be written in the following form:

$${[ \begin{matrix}m \cdot {1}_{3 \times 3} & - m {{}_{2}^{0}{R}{}_{}^{2} ( {ρ}_{C} )}^{⊗} \\ {m ( {}_{2}^{0}{R}{}_{}^{2} {ρ}_{C} )}^{⊗} & {}_{2}^{0}{R}{}_{}^{2} {I}_{D ( 3 \times 3 )}\end{matrix} ]}_{6 \times 6} {\ddot{x}}_{6 \times 1} + {[ \begin{matrix}{[ 0 ]}_{3 \times 3} & - {m}_{2}^{0} {{R}^{2} ( ω \times {ρ}_{C} )}^{⊗} \\ {[ 0 ]}_{3 \times 3} & - {{}_{2}^{0} R ( {}_{}^{2}{I}{}_{D ( 3 \times 3 )}^{2} ω )}^{⊗}\end{matrix} ]}_{6 \times 6} {\dot{x}}_{6 \times 1} = {[ \begin{matrix}\begin{matrix}{}_{}^{0}{F}{}_{ext}^{} + {m}^{0} g + \\ {\sum }_{( i )} ( - {}_{}^{0}{\hat{L}}{}_{i}^{} ) {t}_{i}\end{matrix} \\ \begin{matrix}{}_{}^{0}{M}{}_{ext}^{} + \\ {}^{0} ( {b}_{M} \times {F}_{ext} ) + \\ {\sum }_{( i )} {}_{}^{0}{b}{}_{i}^{} \times ( - {}_{}^{0}{\hat{L}}{}_{i}^{} ) {t}_{i} + \\ {}_{}^{0}{ρ}{}_{C}^{} \times m {}^{0} g\end{matrix}\end{matrix} ]}_{6 \times 1} , . \qquad ( 40 )$$

Equation (40) can also be expressed in the more compact form given in Equation (19). This is the coupled nonlinear set of dynamics equations for the vehicle simulator system.

While the invention is described herein in conjunction with one or more exemplary embodiments, it is evident that many alternatives, modifications, and variations will be apparent to those skilled in the art. Accordingly, exemplary embodiments in the preceding description are intended to be illustrative, rather than limiting, of the spirit and scope of the invention. More specifically, it is intended that the invention embrace all alternatives, modifications, and variations of the exemplary embodiments described herein that fall within the spirit and scope of the appended claims or the equivalents thereof. Any element in a claim that does not explicitly state “means for” performing a specified function, or “step for” performing a specific function, is not to be interpreted as a “means” or “step” clause as specified in 35 U.S.C. §112, ¶ 6. In particular, the use of “step of” in the claims herein is not intended to invoke the provisions of 35 U.S.C. §112, ¶6.

1. A vehicle simulation apparatus, including:
a platform positioned within a three-dimensional workspace;
at least six upper support members positioned outside the three-dimensional workspace;
at least six upper adjustable cables routed from corresponding upper support members and secured to the platform to apply at least a portion of upward tension to the platform, wherein the upper adjustable cables are adjustably extended and retracted in a coordinated fashion to maneuver the platform; and
a vehicle secured to the platform to provide one or more occupants with a simulated experience within a three-dimensional virtual environment during the maneuvering.

2. The vehicle simulation apparatus of claim 1 wherein the upper adjustable cables are routed from the upper support members and secured to the platform in a manner that generally limits rotation of the platform during the maneuvering.

3. The vehicle simulation apparatus of claim 1 wherein the upper support members are arranged in pairs and first and second upper support members of each upper support member pair are generally horizontally spaced from each other.

4. The vehicle simulation apparatus of claim 3, further including:
a fourth upper support member pair positioned outside the three-dimensional workspace, wherein the upper support member pairs are spaced around the outside of the three-dimensional workspace in a generally rectangular pattern.

5. The vehicle simulation apparatus of claim 4 wherein the upper support member pairs are spaced around the outside of the three-dimensional workspace in a generally square pattern.

6. The vehicle simulation apparatus of claim 1, further including:
at least three lower support members positioned outside the three-dimensional workspace;
at least three lower adjustable cables routed from corresponding lower support members and secured to the platform to apply at least a portion of downward tension to the platform, wherein the upper and lower adjustable cables are adjustably extended and retracted in a coordinated fashion to maneuver the platform.

7. The vehicle simulation apparatus of claim 1, further including:
a gravity offload device secured to at least one of the platform and the vehicle to apply at least a portion of upward tension to at least one of the platform and the vehicle during the maneuvering.

8. The vehicle simulation apparatus of claim 1, further including:
a projection screen positioned such that an image displayed on the projection screen during the simulated experience is within view of at least one occupant of the vehicle.

9. The vehicle simulation apparatus of claim 7, the vehicle further including:
at least one input device disposed within the vehicle and accessible to at least one occupant of the vehicle to permit the at least one occupant to interactively control simulated movement of the vehicle within the three-dimensional virtual environment during the simulated experience.

10. A vehicle simulation apparatus, including:
a platform positioned and maneuvered within a three-dimensional workspace;
at least three pairs of upper support members positioned outside the three-dimensional workspace;
at least three pairs of upper adjustable cables routed from corresponding pairs of upper support members and releasably secured to the platform to apply at least a portion of upward tension to the platform, wherein the upper adjustable cables are adjustably extended and retracted in a coordinated fashion to maneuver the platform within the three-dimensional workspace; and
a vehicle releasably secured to the platform to provide one or more occupants with a simulated experience within a three-dimensional virtual environment during the maneuvering.

11. The vehicle simulation apparatus of claim 10, further including:
at least three lower support members positioned outside the three-dimensional workspace;
at least three lower adjustable cables routed from corresponding lower support members and releasably secured to the platform to apply at least a portion of downward tension to the platform, wherein the upper and lower adjustable cables are adjustably extended and retracted in a coordinated fashion during the maneuvering.

12. The vehicle simulation apparatus of claim 11 wherein the lower adjustable cables are routed from the lower support members and releasably secured to the platform to generally limit rotation of the platform during the maneuvering.

13. The vehicle simulation apparatus of claim 10, further including:
a gravity offload device releasably secured to at least one of the platform and the vehicle to apply at least a portion of upward tension to at least one of the platform and the vehicle during the maneuvering, wherein the gravity offload device reduces the load on the upper adjustable cables from at least one of the platform and the vehicle due to gravitational forces at least during the maneuvering.

14. The vehicle simulation apparatus of claim 10, further including:
a projection screen positioned such that an image displayed on the projection screen during the simulated experience is within view of at least one occupant of the vehicle, wherein the displayed image is based at least in part on a simulated position of the vehicle within the three-dimensional virtual environment during the simulated experience and adjusted in a coordinated fashion in conjunction during the maneuvering of the platform within the three-dimensional workspace.

15. The vehicle simulation apparatus of claim 14, the vehicle further including:
at least one input device disposed within the vehicle and accessible to at least one occupant of the vehicle to permit the at least one occupant to interactively control simulated movement of the vehicle within the three-dimensional virtual environment during the simulated experience, wherein the maneuvering of the platform and the image displayed on the projection screen is based at least in part on the at least one occupant interacting with the at least one input device.

16. A method of providing a vehicle simulation, including:
a) maneuvering a platform within a three-dimensional workspace by adjustably extending and retracting at least three pairs of upper adjustable cables in a coordinated fashion to apply at least a portion of upward tension to the platform, wherein the upper adjustable cable pairs are routed from corresponding pairs of upper support members disposed outside the three-dimensional workspace and releasably secured to the platform; and
b) simulating an experience within a three-dimensional virtual environment for one or more occupants of a vehicle releasably secured to the platform during the maneuvering.

17. The method of claim 16, further including:
c) adjustably extending and retracting at least three lower adjustable cables in a coordinated fashion to apply at least a portion of downward tension to the platform during the maneuvering in a), wherein the lower adjustable cables are routed from corresponding lower support members positioned outside the three-dimensional workspace and releasably secured to the platform, wherein the upper and lower adjustable cables are extended and retracted in a coordinated fashion during the maneuvering in a).

18. The method of claim 16, further including:
c) applying at least a portion of upward tension from a gravity offload device to at least one of the platform and the vehicle to reduce the load on the upper adjustable cables from at least one of the platform and the vehicle due to gravitational forces at least during the maneuvering in a), wherein the gravity offload device is releasably secured to at least one of the platform and the vehicle.

19. The method of claim 16, further including:
c) displaying an image displayed on a projection screen based at least in part on a simulated position of the vehicle within the three-dimensional virtual environment during the simulating in b), wherein the projection screen is positioned such that the image displayed on the projection screen is within view of at least one occupant of the vehicle; and
d) adjusting the image displayed on the projection screen in a coordinated fashion in conjunction with the maneuvering in a).

20. The method of claim 19, further including:
e) controlling the maneuvering in a), displaying in c), and adjusting in d) based at least in part on activations of at least one input device by at least one occupant of the vehicle, wherein activations of the at least one input device permit the at least one occupant of the vehicle to interactively control simulated movement of the vehicle within the three-dimensional virtual environment during the simulating in b).
